(19) United States
(12) Patent Application Publication
(10) Pub. No.: US 2026/0164307 A1
(43) Pub. Date: Jun. 11, 2026

(54) DATA SPLITTING IN A MULTI-GENERATION COMMUNICATION SYSTEM

(71) Applicant: QUALCOMM Incorporated, San Diego, CA (US)

(72) Inventors: Punyaslok PURKAYASTHA, San Diego, CA (US); Miguel GRIOT, La Jolla, CA (US); Gavin Bernard HORN, La Jolla, CA (US); Kianoush HOSSEINI, San Diego, CA (US); Ozcan OZTURK, San Diego, CA (US)

(21) Appl. No.: 18/971,910

(22) Filed: Dec. 6, 2024

(51) Int. Cl. H04W 28/08

(52) U.S. Cl. CPC H04W 28/0967

(57) ABSTRACT

Certain aspects of the present disclosure provide techniques for wireless communications by a user equipment (UE). A method generally includes sending, for a core network entity, a data session modification request to move one or more quality of service (QoS) flows of a data session from a first radio access network (RAN) to a second RAN; receiving, from the second RAN, a data session modification response comprising an indication of at least one QoS flow, of the one or more QoS flows, to be moved to the second RAN; and receiving, from the second RAN, a radio resource control reconfiguration associated with the second RAN.

### INTRODUCTION

### Field of the Disclosure

Aspects of the present disclosure relate to wireless communications, and more particularly, to techniques for data splitting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes sending, for a core network entity, a data session modification request to move one or more quality of service (QoS) flows of a data session from a first radio access network (RAN) to a second RAN; receiving, from the second RAN, a data session modification response comprising an indication of at least one QoS flow, of the one or more QoS flows, to be moved to the second RAN; and receiving, from the second RAN, a radio resource control (RRC) reconfiguration message associated with the second RAN.

Certain aspects provide a method for wireless communications by a core network entity. The method includes receiving, in association with a UE, a data session modification request to move one or more QoS flows of a data session from a first RAN to a second RAN; and sending, for the user equipment, a data session modification response comprising an indication of at least one QoS flow of the one or more QoS flows to be moved to the second RAN.

Certain aspects provide a method for wireless communications by a second RAN. The method includes receiving, from a UE, a data session modification request to move one or more QoS flows of a data session from a first RAN to the second RAN; sending, to a core network entity, the received data session modification request; receiving, from the core network entity, an indication of at least one QoS flow of the one or more QoS flows to set up on the second RAN; sending, to the user equipment, a data session modification response comprising an indication of the at least one QoS flow of the one or more QoS flows to move to the second RAN; and sending, to the user equipment, a RRC reconfiguration message associated with the second RAN.

Certain aspects provide a method for wireless communications by a UE. The method includes sending, to a second RAN, during an establishment of a data session, a data session modification request to split one or more QoS flows of the data session between a first RAN and the second RAN; receiving, from the second RAN, a response to the data session modification request comprising a first set of accepted QoS flows to be set up on the first RAN, and a second set of accepted QoS flows to be set up on the second RAN; receiving, from the first RAN, a first RRC reconfiguration message; and receiving, from the second RAN, a second RRC reconfiguration message.

Certain aspects provide a method for wireless communications by a core network entity. The method includes receiving, in association with a UE, a data session modification request to split, during an establishment of a data session, one or more QoS flows of the data session between a first RAN and a second RAN; sending, to the first RAN, based on policies of the core network entity, a first set of accepted QoS flows to set up on the first RAN; and sending, to the second RAN, based on the polices of the core network entity, a second set of accepted QoS flows to set up on the second RAN.

Certain aspects provide a method for wireless communications by a second RAN. The method includes receiving, from a UE, during an establishment of a data session, a data session modification request to split one or more QoS flows of the data session between a first RAN and the second RAN; sending, to a core network entity, the data session modification request; receiving, from the core network entity, a list of accepted QoS flows to set up on the second RAN; sending, to the UE, a RRC reconfiguration message associated with the second RAN; and sending, to the UE, a data session modification response comprising an indication of at least one QoS flow of the one or more QoS flows to be set up on the second RAN.

Certain aspects provide a method for wireless communications by a UE. The method includes determining to split uplink data traffic between a first RAN and a second RAN based on a data split threshold; and sending, to the first RAN, a first buffer status report indicating a status of a first buffer storing data for a first split of the uplink data traffic for the first RAN.

Certain aspects provide a method of wireless communications by a UE. The method includes determining to split uplink data traffic between a first RAN and a second RAN based on a data split threshold; and sending, to the first RAN, a first buffer status report indicating a status of a first buffer storing data for a first split of the uplink data traffic for the first RAN.

Certain aspects provide a method for wireless communications by a network entity. The method includes receiving, from a UE, a first buffer status report indicating a status of a first buffer storing data for a first split of uplink data traffic for the network entity, wherein the uplink data traffic is split between the network entity and a second RAN.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example UE operating in a dual stack operation mode with a 5G RAN and a 6G RAN.

FIG. 6 depicts an example process flow for communications in a network between a UE, a core network entity, a 5G RAN, and a 6G RAN, to send signaling for performing a data split.

FIG. 7 depicts an example process flow for communications in a network between a UE, a core network entity, a 5G RAN, and a 6G RAN, to send signaling for performing a data split.

FIG. 8 depicts an example process flow for communications in a network between a UE, a core network entity, a 5G RAN, and a 6G RAN, to send signaling for performing a data split.

FIG. 9 depicts an example process flow for communications in a network between a UE, a core network entity, a 5G RAN, and a 6G RAN, to send signaling for reporting a buffer status to cause reconfiguration of a data split threshold parameter.

FIG. 10 depicts an example process flow for communications in a network between a UE, a core network entity, a 5G RAN, and a 6G RAN, to send signaling for reporting a buffer status to cause reconfiguration of a data split threshold parameter.

FIG. 11 depicts an example process flow for communications in a network between a UE, a core network entity, a 5G RAN, and a 6G RAN, to send signaling for reporting a buffer status to cause reconfiguration of a data split threshold parameter.

FIG. 12 depicts a method for wireless communications.

FIG. 13 depicts another method for wireless communications.

FIG. 14 depicts another method for wireless communications.

FIG. 15 depicts another method for wireless communications.

FIG. 16 depicts another method for wireless communications.

FIG. 17 depicts another method for wireless communications.

FIG. 18 depicts another method for wireless communications.

FIG. 19 depicts another method for wireless communications.

FIG. 20 depicts aspects of an example communications device.

FIG. 21 depicts aspects of an example communications device.

FIG. 22 depicts aspects of an example communications device.

### DETAILED DESCRIPTION

Aspects of the present disclosure provide apparatuses, methods, processing systems, and computer-readable mediums for enabling data splitting in a multi-generation wireless communication system.

Wireless communications devices, such as user equipments (UEs) may send and receive data over an available radio access network (RAN) link. In certain aspects, a UE may be able to send and receive data over multiple available RANs. For example, a UE may be able to send and receive data over a fifth generation (5G) RAN or a sixth generation (6G) RAN.

In certain aspects, a UE may be configured to operate in a “dual-stack” operation mode in which it simultaneously connects with two different RANs for sending and receiving data during wireless communications. For example, a UE may simultaneously connect with a 5G RAN and a 6G RAN to send and receive data during wireless communications.

In certain aspects, a UE operating in a dual-stack operation mode may be capable of performing data splitting, which includes dividing one or more data streams between two available RANs. For example, a UE operating in a dual-stack operation mode may be communicating a data stream of an established protocol data unit (PDU) session using a first available RAN. A “PDU” session refers to a logical link established between the UE and a given RAN for enabling transfer of data packets between the UE and the RAN. The PDU session may support multiple data formats and include defined parameters for prioritizing the different data types to promote more efficient data communication. In certain aspects, the UE may be capable of splitting the data stream to divide the data stream into multiple quality of service (QoS) flows for communicating using different available RANs. A QoS flow refers to a data transmission having specific performance characteristics (e.g. guaranteed bandwidth, latency, reliability, packet loss, etc.) For example, the UE may perform a data split to assign a specific set of QoS flows (e.g., one or more QoS flows) being communicated using a first RAN to instead be communicated using a second RAN.

Data splitting may engender multiple technical benefits for a UE. For example, performing data splitting may increase uplink reliability at the UE. At certain times, it may be beneficial to perform data splitting to send certain QoS flows over a second RAN having a stronger signal strength, improving uplink reliability. In another example, performing data splitting may increase throughput of wireless communications. At certain times, performing data splitting may be used to balance data loads between multiple RANs, optimizing the use of available resources and increasing throughput.

A UE operating in a dual-stack mode needs to exchange information with one or more network entities to coordinate data splitting across multiple RANs. In some aspects, such information includes indication(s) of which QoS flows are communicated using which RANs. Accordingly, a technical problem arises with respect to how a UE may exchange necessary information with one or more network entities to enable data splitting for dual-stack operation. Certain aspects herein provide a technical solution to this technical problem by providing methods for a UE to send, and a network to receive and process, a data modification request indicating one or more QoS flows to be moved among RANs.

For example, in certain aspects, a UE communicating using an established PDU session over a first RAN sends a data modification request to move one or more QoS flows of the PDU session from the first RAN to a second RAN. The UE then receives from a second RAN a data session modification response including an indication of one or more QoS flows to be moved (split) to the second RAN. For example, the second RAN may perform an admission control to determine a list of accepted QoS flows to set up on the second RAN, and accordingly may send an indication of the one or more accepted QoS flows to the UE. This provides the technical benefit of allowing the UE to perform data splitting by communicating the list of accepted QoS flows using the second RAN, which in-turn increases throughput and/or reliability and reduces latency.

In certain aspects, the UE may perform data splitting during an initial establishment of a data session. For example, the UE may send, to a second RAN, during an establishment of a data session, a data session modification request to split one or more QoS flows between a first RAN and the second RAN. For example, the UE may request to establish one or more QoS flows of the data session on the second RAN, and then further request to establish a set of remaining QoS flows of the data session on the first RAN. This provides the technical benefit of allowing the UE to perform data splitting to split one or more QoS flows when establishing a data session. Performing data splitting during an initial establishment of a data session provides various technical benefits. As an example, by utilizing both available RANs at the outset of a data session, the UE aggregates available bandwidth, leading to increased throughput. Performing data splitting during an initial establishment of a data session further distributes data traffic more efficiently, providing the technical benefit of optimizing resource utilization between two RANs by balancing data loads to enhance overall network performance, thereby reducing the likelihood of congestion on any single link.

Another technical problem arises with respect to determining when a UE may benefit from performing data splitting, such as when the UE may benefit from moving one or more QoS flows to a second available RAN. Certain aspects herein provide a technical solution to this technical problem by providing techniques for determining a split of one or more QoS flows to move to a second available RAN when performing data splitting. In certain aspects, the UE communicating data using a first RAN may determine a split of one or more QoS flows to move to a second RAN, and then send a data modification request to a second RAN. The UE may then receive, from the second RAN, a list of accepted QoS flows to set up on the second accessible RAN for performing the data split.

For example, the UE may determine the split of the one or more QoS flows to be moved to the second RAN based on user plane (UP) measurements of a first RAN link for sending data traffic using a first RAN, and a second RAN link for sending data traffic using a second RAN. UP measurements refer to metrics collected to evaluate the performance of a given RAN link used for data transmission between the UE and an associated RAN. UP measurements may include, but are not limited to, throughput, latency, packet loss, jitter, signal quality (e.g. signal-to-noise ratios, reference signal received power measurements, and reference signal received quality measurements,) and congestion levels measured in a downlink (DL) and/or an uplink (UL) direction. UP measurements in the DL direction can be performed by the UE, while UP measurements in the UL direction may be performed by a given RAN node which may then forward the UP measurements to the UE. For example, a UE communicating data using a first RAN link associated with a first RAN may determine UP measurements of the first RAN link, such as signal quality and data throughput, which may be insufficient for communicating one or more QoS flows. In certain aspects, the UE may perform data splitting to move the one or more QoS flows to a second RAN based on UP measurements of a second RAN link associated with the second RAN, such as improved signal quality and data throughput as compared to the signal quality and data throughput of the first RAN link. Accordingly, in certain aspects, the UE can determine the split of the one or more QoS flows to move from a first RAN to a second RAN when performing data splitting based on UP measurements of accessible RAN links associated with the RAN.

As another example, the UE may determine the split of the one or more QoS flows to be moved to the second RAN based on access traffic steering, switching, and splitting (ATSSS) rules. ATSSS rules are mechanisms for controlling how data traffic is distributed across multiple RANs to optimize performance for the UE. The rules may govern how to steer, switch, and split traffic across different RANs. “Steering” may refer to which RAN should carry specific types of traffic. For example, a UE may steer data of a traffic type that requires strict latency and throughput requirements, such as gaming traffic, to a RAN having sufficient throughput and latency. “Switching” may refer to moving traffic from one RAN to another based on changing network conditions, such as changing signal strengths. “Splitting” may refer to dividing one or more data streams between two available RANs. In certain aspects, the UE may determine that an application whose traffic is being communicated cannot access a first RAN, and may perform data splitting to move the one or more QoS flows to a second accessible RAN that can communicate the traffic. In certain aspects, the UE may determine that ATSSS rules for a first RAN and a second RAN include a pre-configured desired distribution of traffic between the two RANs (e.g., 20% on the first RAN and 80% on the second RAN.) Accordingly, in certain aspects, the UE can determine the split of the one or more QoS flows to move from a first RAN to a second RAN when performing data splitting based on ATSSS rules for accessing the accessible RANs.

As another example, the UE may determine the split of the one or more QoS flows to be moved to the second RAN based on QoS parameters of the one or more QoS flows. QoS parameters refer to characteristics and requirements for data transmission associated with a given QoS flow. QoS parameters may include, for example, a priority level, bandwidth requirements, latency requirements, acceptable packet loss rate requirements, and other known parameters that may be leveraged by the UE and associated network entities to effectively manage and prioritize data traffic. For example, the UE may perform data splitting to move one or more QoS flows based on QoS parameters requiring increased throughput and reduced latency to a second RAN having improved throughput and reduced latency compared to a first RAN being used to communicate the one or more QoS flows. Accordingly, in certain aspects, the UE can determine the split of the one or more QoS flows to move from a first RAN to a second RAN when performing data splitting based on QoS parameters of the one or more QoS flows.

In certain aspects, the UE may perform data splitting based on a configured data split threshold. A data split threshold may refer to a predefined criterion or set of conditions that determine when to split traffic between multiple RANs. In certain aspects, the data split threshold may be related to available bandwidth on each RAN, latency metrics, packet loss rates, QoS parameters for data traffic, or other suitable wireless communication metrics for determining when it may be beneficial for the UE to perform data splitting.

Another technical problem arises with respect to when a UE may benefit from receiving a reconfigured (updated) data split threshold for managing when the UE performs data splitting. Certain aspects herein provide a technical solution to this technical problem by providing techniques for a UE to send signaling, to a first RAN, including a first buffer status report indicating a status of a first buffer storing data for a first split of data traffic for the first RAN.

For example, the UE may split uplink data traffic between a first RAN and a second RAN based on a data split threshold, and then send, to the first RAN, a first buffer status report indicating a status of a first buffer storing data for a first split of the uplink data traffic for the first RAN. A buffer status report (BSR) may refer to information sent by a UE to a network entity (e.g. a RAN) to inform the network entity about an amount of data that is within temporary storage(s) (e.g., buffer(s)) and waiting to be transmitted. In certain aspects, the first buffer status report causes the first RAN to reconfigure the UE with an updated data split threshold. This provides the technical benefit of causing the UE to determine updated splits of data based on the updated data split threshold, which provides a benefit of improving resource management, reliability of connectivity, and wireless communication performance between the UE and associated RANs.

In certain aspects, when the data volume for a given QoS flow, data radio bearer, or logical channel group is above an existing data split threshold, a UE could report an updated BSR before splitting. A data radio bearer (DRB) refers to a transport channel for carrying data associated with one or more QoS flows. A logical channel group (LCG) refers to a collection of logical channels for grouping together data flows based on shared characteristics. For example, the UE may send a buffer status report, and then wait for a defined interval to receive an updated data split threshold before performing a data split. In certain aspects, after the defined interval, the UE may then send, to the first RAN, a first split of the uplink data traffic based on an existing data split threshold. In certain aspects, the UE may receive, from the first RAN, the updated data split threshold, causing the UE to determine whether to perform a data split based on the updated data split threshold. This provides the technical benefit of limiting the tendency for the UE to perform data splitting if the first RAN is able to accommodate additional data volume without splitting, thereby reducing power consumption by limiting the number of active RANs being used.

In another example, the UE may further send, to the first RAN, a recommended updated data split threshold associated with one of a QoS flow, a DRB or a LCG. The UE may then wait to receive a response from the network including an updated (reconfigured) data split threshold. This provides the technical benefit of causing the UE to determine updated splits of data based on the updated data split threshold, which provides the benefit of improving resource management, reliability of connectivity, and wireless communication performance between the UE and associated RANs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

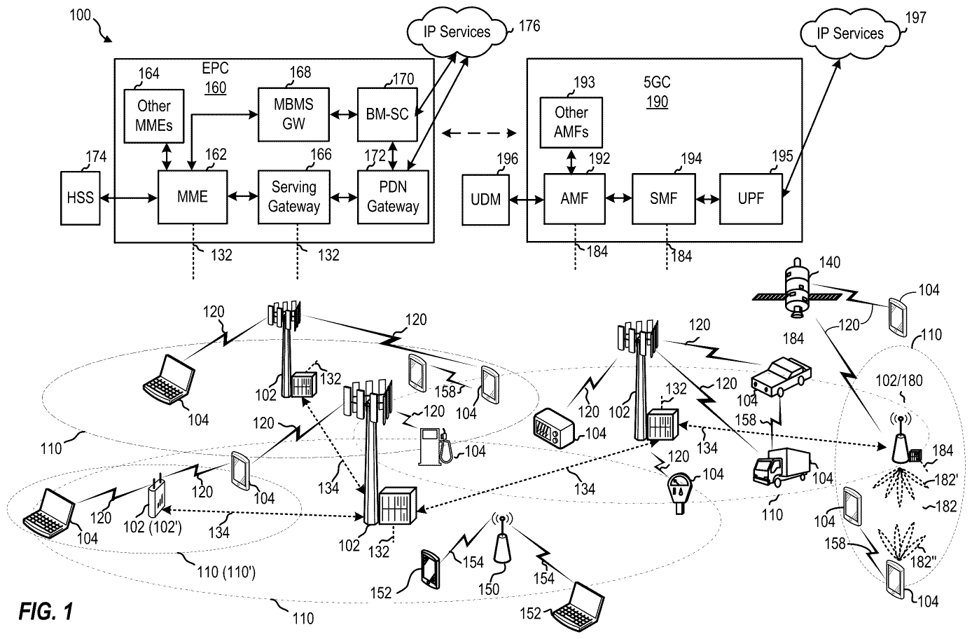

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

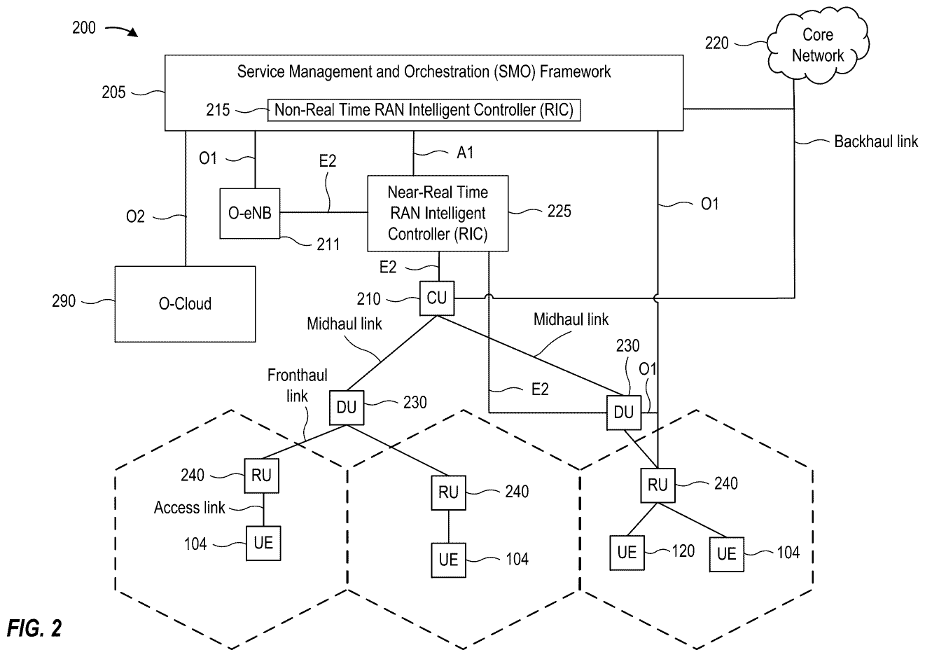

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

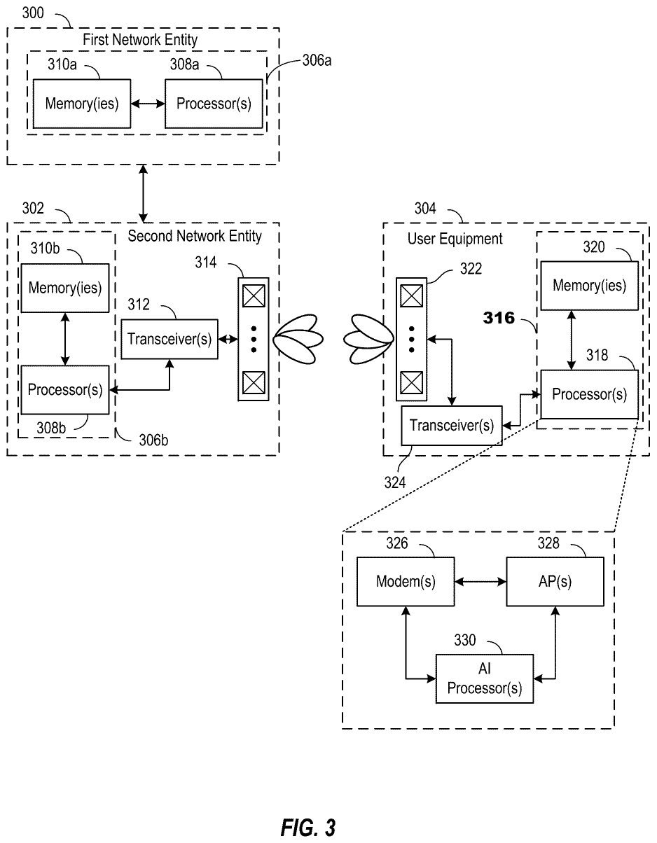

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

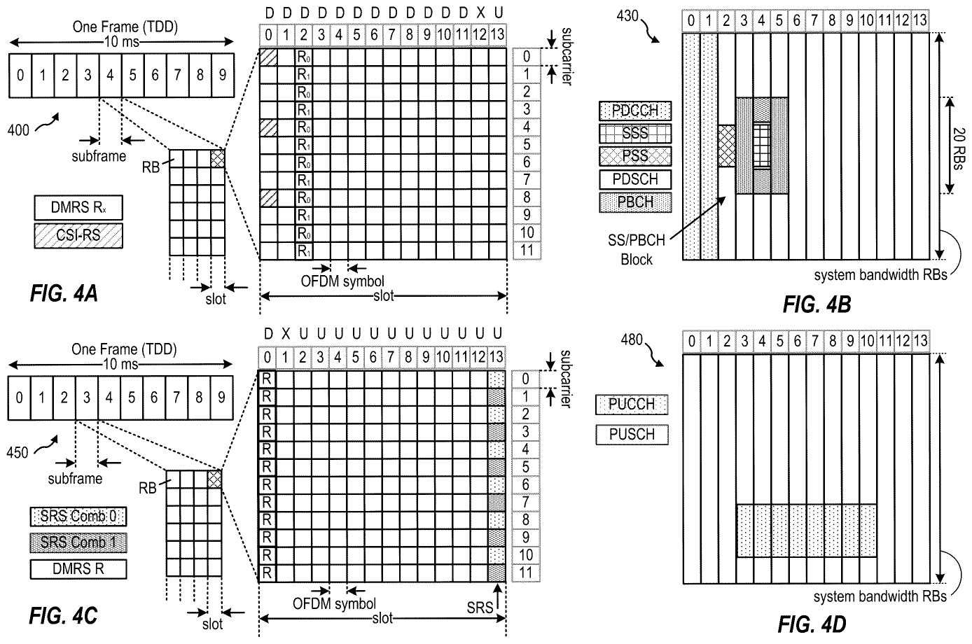

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Data Splitting in a Multi-generation Wireless Communication System

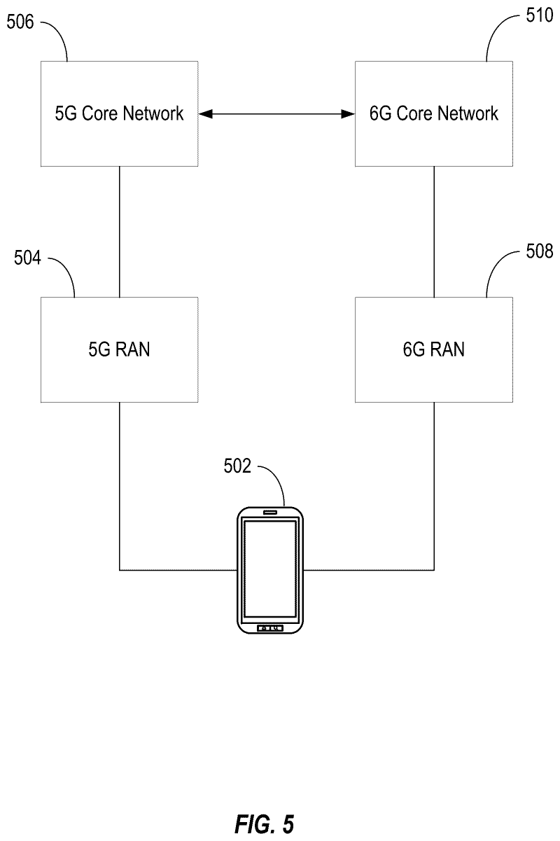

FIG. 5 depicts an example UE 502 operating in a dual-stack operation mode. UE 502 is simultaneously connected with a 5G RAN 504 and a 6G RAN 508 for sending and receiving data during wireless communications. UE 502 is capable of performing data splitting to move one or more QoS flows from the 5G RAN 504 to 6G RAN 508. At certain times, it may be beneficial to move one or more QoS flows from 5G RAN 504 to 6G RAN 508 to, for example, utilize a given RAN having a stronger signal strength to improve uplink reliability. At certain other times, performing data splitting may balance data loads between the multiple RANs, optimizing the use of available resources and increasing throughput. For example, UE 502 may send data for an established PDU session to 5G RAN 504 for forwarding to a 5G core network 506. UE 502 may then perform data splitting to send one or more QoS flows to the 6G RAN 508 for forwarding to a 6G core network 510. Accordingly, UE 502 may be capable of performing data splitting to simultaneously use different accessible RANs for sending and receiving data during wireless communications.

### Example Techniques for Performing Data Splitting During Multi-Generation Wireless Communication

As discussed, in certain aspects a UE may send, and a network entity may receive and process, a data modification request indicating one or more QoS flows to be moved among RANs.

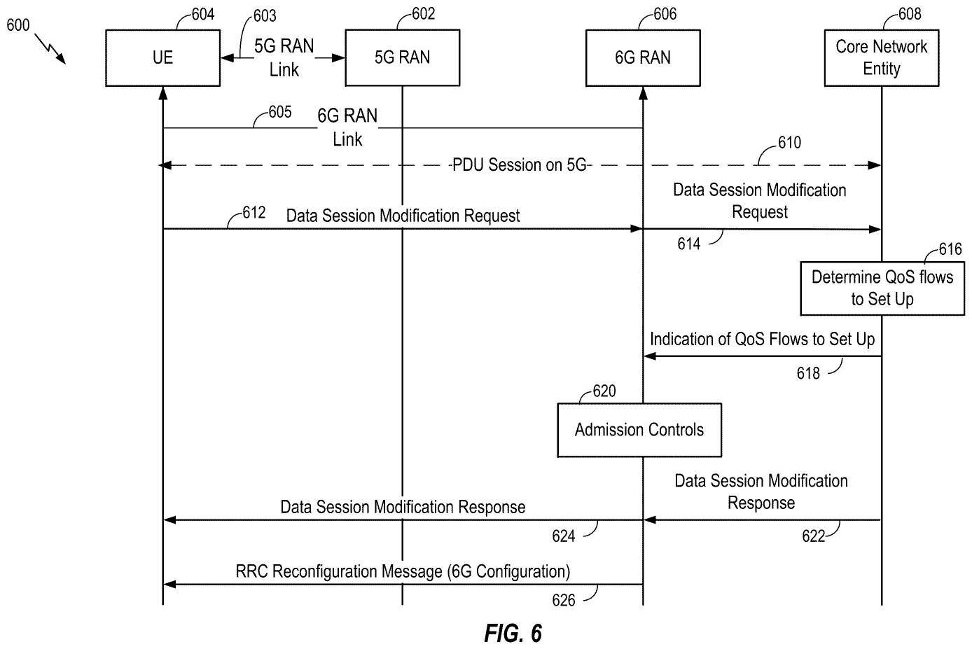

FIG. 6 depicts a process flow 600 for communications in a network between a 5G RAN 602, a UE 604, a 6G RAN 606, and a core network entity 608. In some aspects, the 5G RAN 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and 5G RAN 602 may be another type of network entity or network node, such as those described herein. Note that any operations or signaling illustrated with dashed lines may indicate that that operation or signaling is an optional or alternative example.

At 610, an established PDU session is maintained by UE 604 communicating with core network entity 608 via the 5G RAN 602. For example, UE 604 may send data traffic (e.g. web browsing traffic, video streaming, voice call data, etc.) via a RAN link 603, to 5G RAN 602. Core network entity 608 may ensure that QoS flows of communicated data traffic are handled according to their service needs. For example, a given QoS flow may have a latency or bandwidth requirements. UE 604 is operating in a dual-stack operation mode, and is capable of performing data splitting by moving one or more QoS flows from 5G RAN 602 to 6G RAN 606.

At 612, UE 604 sends, to 5G RAN 602 a data session modification request for performing data splitting to move one or more QoS flows to 6G RAN 606. As used herein, a “data session modification request” refers to signaling sent by a UE, to a network entity (e.g. a core network entity) for adjusting an ongoing data session, such as by moving one or more QoS flows from a first available RAN to a second available RAN. In certain aspects, UE 604 may send the data session modification request to perform data splitting based on UP measurements of a given RAN link for communicating data between the UE and a given RAN. For example, UE 604 communicating data using 5G RAN 602 may determine UP measurements of a 5G RAN link 603 include insufficient signal quality and data throughput for communicating one or more QoS flows. At 612, UE 604 may then send a data session modification request to perform data splitting to move the one or more QoS flows to 6G RAN 606 based on UP measurements of a 6G RAN link 605 including signal quality and data throughput measurements that are improved compared to 5G RAN link 603. Accordingly, in certain aspects, the UE can perform data splitting to move one or more QoS flows from a first 5G RAN 602 to a second 6G RAN 606 based on UP measurements of accessible RAN links associated with each available RAN (here, UP measurements of RAN link 603 associated with 5G RAN 602, and UP measurements of RAN link 605 associated with 6G RAN 606).

In certain aspects, UE 604 may send the data session modification request to perform data splitting based on ATSSS rules for accessing the RANs 602, 606. For example, if an ATSSS rule blocks video streaming traffic from being transmitted using 5G RAN 602, then UE 604 may send a data modification request to perform data splitting to move one or more QoS flows associated with video streaming traffic from 5G RAN 602 to 6G RAN 606. In certain aspects, ATSSS rules for accessing a first RAN and a second RAN may include a pre-configured distribution of traffic between the links.

For example, ATSSS rules for accessing 5G RAN 602 and 6G RAN 606 may include a distribution of traffic that apportions twenty percent of data traffic to 5G RAN 602 and eighty percent of data traffic to 6G RAN 606. UE 604 may then send a data session modification request to perform data splitting to move one or more QoS flows to maintain the preconfigured distribution of traffic based on the ATSSS rules for accessing the links.

In another example, ATSSS rules for accessing 5G RAN 602 and 6G RAN 606 may control whether the application whose traffic is being carried by the data session can access an associated RAN link (such as 5G RAN link 603 and 6G RAN link 605). UE 604 may send a data session modification request to perform a data split to move one or more QoS flows that are unable to be carried over a first RAN to a second available RAN. Accordingly, in certain aspects, the UE 604 can perform data splitting to move one or more QoS flows among two or more RANs based on ATSSS rules for accessing respective RAN links associated with each respective RAN.

In certain aspects, UE 604 may send the data session modification request to perform data splitting based on QoS parameters of one or more QoS flows. For example, if UE 604 is sending one or more QoS flows having increased bandwidth and reduced latency requirements, UE 604 may send a data session modification request to move the one or more QoS flows to 6G RAN 606 having increased bandwidth and reduced latency as compared to 5G RAN 602. Accordingly, in certain aspects, the UE can perform data splitting to move one or more QoS flows among two or more RANs based on QoS parameters of one or more QoS flows.

At 614, 5G RAN 602 sends, to core network entity 608, the data session modification request. In certain aspects, the data session modification request may include a list of QoS flows to be moved to 6G RAN 606. For example, the list of QoS flows in the data session modification request may include QoS flow identifiers (QoS flow IDs) for each QoS flow to be moved. In another example, a data session modification request may include a list of QoS flows to be moved (from 5G RAN 602 to 6G RAN 606), where each individual QoS flow includes an identifier including an assigned integer (e.g., 1, 2, 3, etc.) for differentiating between the different QoS flows. The data session modification request may further include PDU session identifiers of a similar format (e.g., assigned integers) for representing different PDU sessions established between UE 604 and core network entity 608. In certain aspects, the data session modification request may further include QoS parameters for satisfying minimum QoS requirements for each respective QoS flow being moved. For example, UE 604 may send a data session modification request that includes a QoS parameter for satisfying a minimum bandwidth requirement for a specific QoS flow to be moved that is associated with gaming data traffic.

At 616, core network entity 608 determines QoS flows to set up on 6G RAN 606 based on, for example, network policies. In certain aspects, network policies may include predefined rules for determining whether a QoS flow may be set up for an established connection between the core network and a given UE. Network policies may consider various factors including but not limited to, user subscriptions, service types, network conditions, resource availability, and priority levels, ensuring that only authorized and prioritized QoS flows are set up in accordance with the network policies of the core network. For example, core network entity 608 may include service type policies that allow set up of a QoS flow for video streaming traffic having a guaranteed bitrate requirement, but restrict set up of a different QoS flow for bulk data transfers where high QoS is unnecessary. In another example, core network entity 608 may restrict a low-priority QoS flow (e.g. background data synchronization service) from being set up during peak hours based on network resource availability policies, while allowing a different high-priority QoS flow for services like emergency calls to be set up.

At 618, core network entity 608 sends, to 6G RAN 606, an indication of the QoS flows to be moved from 5G RAN 602 for setting up on 6G RAN 606. For example, core network entity 608 may send a list of QoS flow identifiers including example QoS flows 1, 2, 4, and 6 for set up on 6G RAN 606. Core network entity 608 may further include PDU session identifiers (e.g. PDU session 1) to identify the PDU session associated with the QoS flows to be set up.

At 620, 6G RAN 606 performs admission controls to determine a list of accepted QoS flows to be set up. As used herein, “admission controls” refer to mechanisms for determining whether QoS flows may be established at a given RAN based on network capacity and resource availability (e.g. radio resources such as bandwidth, power, etc.) for setting up with QoS flows without compromising existing services.

At 622, core network entity 608 sends, to 6G RAN 606, a data session modification response for forwarding to UE 604.

At 624, 6G RAN 606 sends, to UE 604, the data session modification response. The data session modification response includes the list of accepted QoS flows to move from 5G RAN 602 for setting up on 6G RAN 606. The data session modification response may further include one or more PDU session identifiers associated with one or more QoS flows within the list of accepted QoS flows.

At 626, 6G RAN 606 sends, to UE 604, a radio resource control (RRC) reconfiguration message. The RRC reconfiguration message includes signaling for causing UE 604 to modify or add parameters and configurations of various layers of the protocol stack at the UE-the physical layer, the MAC layer, the RLC layer, the PDCP layer, the SDAP layer, and the RRC layer-for communicating data of the accepted QoS flows over 6G RAN 606. The RRC reconfiguration message may include data radio bearer (DRB) configurations for respective QoS flows of the list of accepted QoS flows. As used herein, “DRB configurations” may include parameters related to the DRB that pertain to the upper layers of the protocol stack at the UE, including the MAC layer, the RLC layer, the PDCP layer, and the SDAP layer.

In certain aspects, UE 604 may instead be communicating data traffic for an established PDU session on 6G RAN 606. Accordingly, UE 604 could then perform data splitting by sending a data session modification request to move one or more QoS flows from 6G RAN 606 to 5G RAN 602 in a similar manner as described above.

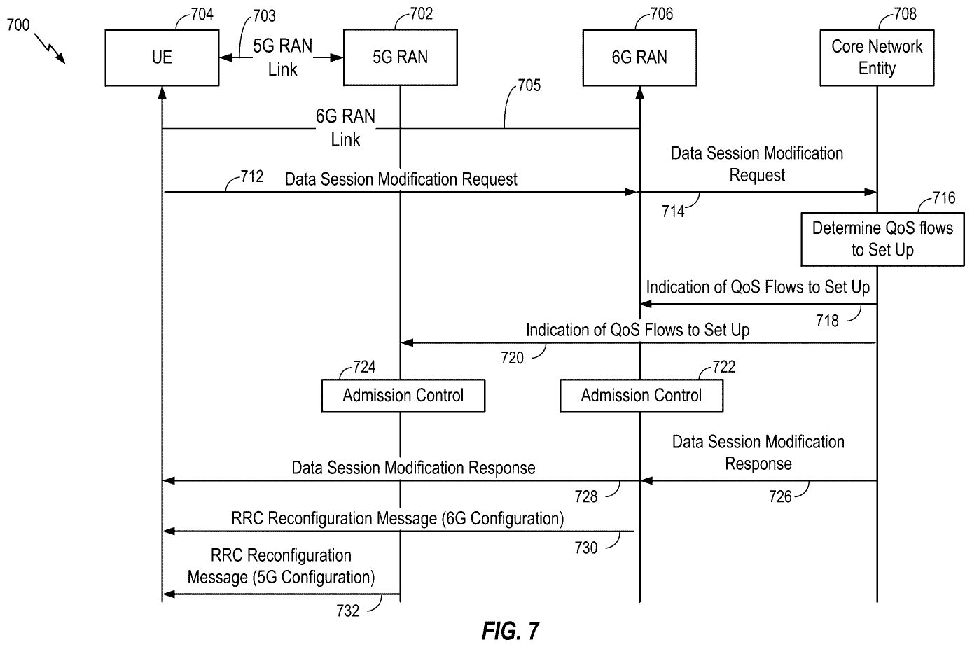

Accordingly, UE 604 performs data splitting by moving one or more QoS flows of an established PDU session from 5G RAN 602 to a 6G RAN 606, improving the balance of data loads between the RANs, thereby providing the technical benefit of optimizing use of available network resources and increasing throughput. At certain times, if 6G RAN 606 has stronger signal strength compared to 5G RAN 602, performing data splitting to move one or more QoS flows from 5G RAN 602 to 6G RAN 606 further provides UE 604 with the technical benefit of improved uplink reliability and increased throughput. FIG. 7 depicts a process flow 700 for communications in a network between a 5G RAN 702, a UE 704, a 6G RAN 706, and a core network entity 708. In some aspects, the 5G RAN 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and 5G RAN 702 may be another type of network entity or network node, such as those described herein. Note that any operations or signaling illustrated with dashed lines may indicate that that operation or signaling is an optional or alternative example.

Process flow 700 includes a UE 704 is operating in a dual-stack operation mode for simultaneously connecting to a 5G RAN 702, and a 6G RAN 706. Process flow 700 depicts techniques for enabling UE 704 to perform a data split during an initial establishment of a data session for setting up one or more QoS flows on 5G RAN 702, and one or more different QoS flows on 6G RAN 706. In certain aspects, 712-718 and 726-730 are the same or similar as 612-618 and 622-626 of FIG. 6.

For example, at 712-714, UE 704 sends, to a core network entity 708, via 6G RAN 706, a data session modification request to split one or more QoS flows between 5G RAN 702 and 6G RAN 706. The data session modification request may include a list of QoS flows to be established including QoS flows 1, 2, 3, and 4. UE 704 may request, for example, to establish QoS flows 1, 2, and 3 over 6G RAN 706, and to establish QoS flow 4 over 5G RAN 702. As previously discussed, performing data splitting during an initial establishment of a data session further distributes data traffic more efficiently, providing the technical benefit of optimizing resource utilization between two RANs by balancing data loads to enhance overall network performance, thereby reducing the likelihood of congestion on any single link. In certain aspects, the data session modification request may be sent to core network entity 708 using 5G RAN 702. UE 704 may determine to split the QoS flows using similar techniques as described above, such as based on UP measurements of RAN links between UE and the accessible RANs (here, 5G RAN link 703 and 6G RAN link 705), ATSSS rules for accessing the RAN links 703, 705, and QoS parameters of the QoS flows.

At 716, core network entity 708 determines QoS flows to set up on each of 5G RAN 702 and 6G RAN 706 based on, for example, network policies. The network policies may consider various factors including but not limited to, user subscriptions, service types, network conditions, resource availability, and priority levels, ensuring that only authorized and prioritized QoS flows are set up in accordance with the network policies of the core network.

At 718, core network entity 708 sends, to 6G RAN 706, an indication of the QoS flows to be set up. For example, core network entity 608 may send a list of QoS flow identifiers including example QoS flows 1, 2, and 3 for set up on 6G RAN 606.

At 720, core network entity 708 further sends an indication including a list of QoS flows to set up on 5G RAN 702. For example, core network entity 608 may send a QoS flow identifier including an example QoS flow 4 for setting up on 5G RAN 602. In some examples, core network entity 708 may send a list of multiple different QoS flow identifiers to be set up on 5G RAN 602. At 722, 6G RAN 706 performs admission controls to determine a list of accepted QoS flows to be set up at 6G RAN 706 based on network capacity and resource availability (e.g. radio resources such as bandwidth, power, etc.) for setting up with QoS flows without compromising existing services.

At 724, 5G RAN 702 performs admission controls to determine a list of accepted QoS flows in a similar manner as described above in connection with the admission controls performed by 6G RAN 706.

At 726, core network entity 708 sends, to 6G RAN 706 a data session modification response. The data session modification response includes the list of accepted QoS flows to set up on 6G RAN 706 and 5G RAN 702 respectively.

At 728, 6G RAN 706 sends the data session modification response to UE 704, such that UE 704 may receive and proceed with setting up the list of accepted QoS flows over 5G RAN 702 and 6G RAN 706.

At 730, 6G RAN 706 sends, to UE 704, an RRC reconfiguration message for enabling UE 704 to communicate the list of the accepted QoS flows over 6G RAN 706. For example, the RRC reconfiguration message may include DRB configurations for respective QoS flows of the list of accepted QoS flows. The DRB configurations may include, for example, QoS parameters (e.g. guaranteed bit rate, priority level, latency requirements, etc.) and logical channel configurations for defining how data of a given QoS flow should be transmitted, including coding schemes, modulation types, and other physical layer parameters.

At 732, 5G RAN 702 sends, to UE 704, an RRC reconfiguration message for enabling UE 704 to communicate the list of the accepted QoS flows over 5G RAN 702 in a similar manner as described above in connection with the RRC reconfiguration message sent by 6G RAN 706

Accordingly, UE 704 may perform data splitting during initial establishment of a data session to set up one or more QoS flows on a first RAN and a one or more different QoS flows on second RAN (such as 5G RAN 602 and 6G RAN 606). Performing data splitting during an initial establishment of a data session distributes data traffic more efficiently at the outset of a data session, thereby providing the technical benefit of optimizing resource utilization between two accessible RANs by balancing data loads to enhance overall network performance, reducing the likelihood of congestion on any single link. Performing a data split during an initial establishment of a data session further allows UE 604 to aggregates available bandwidth, thereby providing the technical benefit of increased throughput when sending and receiving wireless communications. In certain aspects, performing data splitting during an initial establishment of a data session further ensures that QoS flows are split based on various factors (e.g. UP measurements of RAN links between the UE and a given RAN, ATSSS rules, and QoS parameters for the QoS flows to be communicated) such that respective QoS flows are set up on a specific accessible RANs having improved properties as compared to alternative accessible RANs. Performing data splitting to set up respective QoS flows on RANs having improved properties as compared to alternative accessible RANs provides the technical benefit of improving wireless communication performance (for transmitting the respective QoS flows), such as by increasing reliability, increasing throughput, and reducing delay.

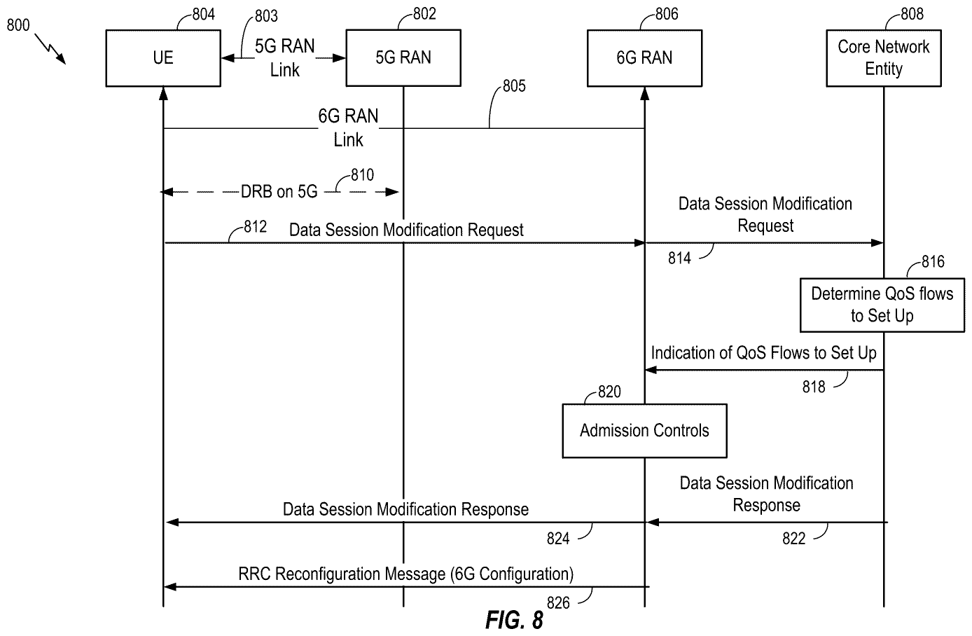

FIG. 8 depicts a process flow 800 for communications in a network between a 5G RAN 802, a UE 804, a 6G RAN 806, and a core network entity 808. In some aspects, the 5G RAN 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and 5G RAN 802 may be another type of network entity or network node, such as those described herein. Note that any operations or signaling illustrated with dashed lines may indicate that that operation or signaling is an optional or alternative example.

In process flow 800, UE 604 performs data splitting to move one or more QoS flows from a 5G DRB to 6G RAN 806. For example, at 810, UE 804 may have an active DRB on 5G using a 5G RAN 802 for transmitting and receiving data traffic. In certain aspects, the data session modification request may include a request to move a subset of one or more of the QoS flows of a DRB for communicating uplink traffic from the 5G RAN 802 to 6G RAN 806.

At 812, UE 804 sends, to 5G RAN 802 a data session modification request for performing data splitting to move one or more QoS flows of the 5G DRB at 810 to a 6G RAN 806. In certain aspects, UE 804 may send the data session modification request to perform data splitting based on UP measurements of a given RAN link for communicating data between the UE and a given RAN. For example, UE 804 communicating data using 5G RAN 802 may determine that UP measurements of a 5G RAN link 803 include insufficient signal quality and data throughput for communicating one or more QoS flows. UE 804 may then send a data session modification request to perform data splitting to move the one or more QoS flows to 6G RAN 806 based on UP measurements of a 6G RAN link 805 including improved signal quality and data throughput measurements as compared to 5G RAN link 803. Accordingly, in certain aspects, UE 804 can perform data splitting to move one or more QoS flows of a DRB on 5G RAN 802 to 6G RAN 806 based on UP measurements of accessible RAN links associated with each available RAN (here, UP measurements of 5G RAN link 803 associated with 5G RAN 802, and UP measurements of 6G RAN link 805 associated with 6G RAN 806).

In certain aspects, UE 804 may send the data session modification request to perform data splitting based on ATSSS rules for accessing the RANs 802, 806. For example, if an ATSSS rule blocks video streaming traffic from being transmitted using 5G RAN 802, then UE 804 may send a data modification request to perform data splitting to move one or more QoS flows associated with video streaming traffic from 5G RAN 802 to 6G RAN 806. In certain aspects, ATSSS rules for accessing a first RAN and a second RAN may include a pre-configured distribution of traffic between the links. In some examples, ATSSS rules for accessing 5G RAN 802 and 6G RAN 806 may include a distribution of traffic that apportions twenty percent of data traffic to 5G RAN 802 and eighty percent of data traffic to 6G RAN 806. UE 804 may then send a data session modification request to perform data splitting to move one or more QoS flows to maintain the preconfigured distribution of traffic based on the ATSSS rules for accessing the RANs.

In certain aspects, UE 804 may send the data session modification request to perform the data split without having to be configured with (e.g. by 6G RAN link 805) an uplink data split threshold. For example, when UE 804 moves one or more QoS flows of a 5G DRB to 6G RAN 806, as shown in FIG. 8, the data split may be inherently determined after the one or more QoS flows have been moved, based on the distribution of the QoS flows being communicated over 5G RAN 802 and 6G RAN 806 respectively.

In another example, ATSSS rules for accessing 5G RAN 802 and 6G RAN 806 may control whether the application whose traffic is being carried by the data session can access an associated RAN (or RAN link such as 5G RAN link 803 and 6G RAN link 805). UE 804 may send a data session modification request to perform a data split to move one or more QoS flows that are unable to be carried over a first RAN to a second available RAN. Accordingly, in certain aspects, the UE 804 can perform data splitting to move one or more QoS flows among two or more RANs based on ATSSS rules for accessing respective RANs.

In certain aspects, UE 804 may send the data session modification request to perform data splitting based on QoS parameters of one or more QoS flows. For example, if UE 804 is sending one or more QoS flows having increased bandwidth and reduced latency requirements, UE 804 may send a data session modification request to move the one or more QoS flows to 6G RAN 806 having increased bandwidth and reduced latency as compared to 5G RAN 802. Accordingly, in certain aspects, the UE can perform data splitting to move one or more QoS flows among two or more RANs based on QoS parameters of one or more QoS flows.

At 814, 5G RAN 802 sends, to core network entity 808, the data session modification request. In certain aspects, the data session modification request may include a list of QoS flows to be moved to 6G RAN 806. For example, the list of QoS flows in the data session modification request may include QoS flow identifiers (QoS flow IDs) for each QoS flow to be moved. In another example, a data session modification request may include a list of QoS flows to be moved (from 5G RAN 802 to 6G RAN 806), where each individual QoS flow includes an identifier including an assigned integer (e.g., 1, 2, 3, etc.) for differentiating between the different QoS flows. In certain aspects, the data session modification request may further include QoS parameters for satisfying minimum QoS requirements for each respective QoS flow being moved. For example, UE 804 may send a data session modification request that includes a QoS parameter for satisfying a minimum bandwidth requirement for a specific QoS flow to be moved that is associated with gaming data traffic.

At 816, core network entity 808 determines QoS flows to set up on 6G RAN 806 based on, for example, network policies for determining whether a QoS flow may be set up for an established connection between the core network and a given UE. For example, core network entity 808 may include service type policies that allow set up of a QoS flow for video streaming traffic having a guaranteed bitrate requirement, but restrict set up of a different QoS flow for bulk data transfers where high QoS is unnecessary. In another example, core network entity 808 may restrict a low-priority QoS flow (e.g. background data synchronization service) from being set up during peak hours based on network resource availability policies, while allowing a different high-priority QoS flow for services like emergency calls to be set up.

At 818, core network entity 808 sends, to 6G RAN 806, an indication of the QoS flows to be moved from 5G RAN 802 for setting up on 6G RAN 806. For example, core network entity 808 may send an indication including a list of QoS flow identifiers including example QoS flows 1, 2, 4, and 6 for set up on 6G RAN 806. Core network entity 808 may further send PDU session identifiers (e.g. PDU session 1) to identify the PDU session associated with the QoS flows to be set up.

At 820, 6G RAN 806 performs admission controls to determine a list of accepted QoS flows to be set up. For example, 6G RAN 806 may perform admission controls to determine whether the indicated QoS flows can be set up without compromising existing service, such as based resource availability (e.g. radio resources such as bandwidth, power, etc.) and network capacity.

At 822, core network entity 808 sends, to 6G RAN 806, a data session modification response for forwarding to UE 804.

At 824, 6G RAN 806 sends, to UE 804, the data session modification response. The data session modification response includes the list of accepted QoS flows to move from 5G RAN 802 for setting up on 6G RAN 806. The data session modification response may further include one or more PDU session identifiers associated with one or more QoS flows within the list of accepted QoS flows.

At 826, 6G RAN 806 sends, to UE 804, a radio resource control (RRC) reconfiguration message. The RRC reconfiguration message includes signaling for causing UE 804 to modify radio parameters and configurations for communicating data of the accepted QoS flows over 6G RAN 806. The RRC reconfiguration message may include DRB configurations for respective QoS flows of the list of accepted QoS flows. The DRB configurations may further include one or more of QoS parameters (e.g. guaranteed bit rate, priority level, latency requirements, etc.) and logical channel configurations for defining how data of a given QoS flow should be transmitted, including coding schemes, modulation types, and other physical layer parameters.

UE 804 thus performs data splitting by moving one or more QoS flows of a DRB with uplink traffic from a 5G RAN 802 to a 6G RAN 806, thereby providing multiple technical benefits. For example, performing the data splitting to move one or more QoS flows from 5G RAN 802 to 6G RAN 806 improves the balance of data loads between the RANs, thereby providing the technical benefit of optimizing the use of available network resources and increasing throughput. At certain times, if 6G RAN 806 has stronger signal strength compared to 5G RAN 802, performing data splitting to move one or more QoS flows from 5G RAN 802 to 6G RAN 806 provides the technical benefit of improved uplink reliability and increased throughput.

### Example Signaling of Buffer Status Reporting for Reconfiguring Data Split Thresholds For Multi-generation Wireless Communication

As discussed, in certain aspects, a UE may be configured to send signaling, to a first RAN, including a first buffer status report indicating a status of a first buffer storing data for a first split of uplink data traffic for the first RAN.

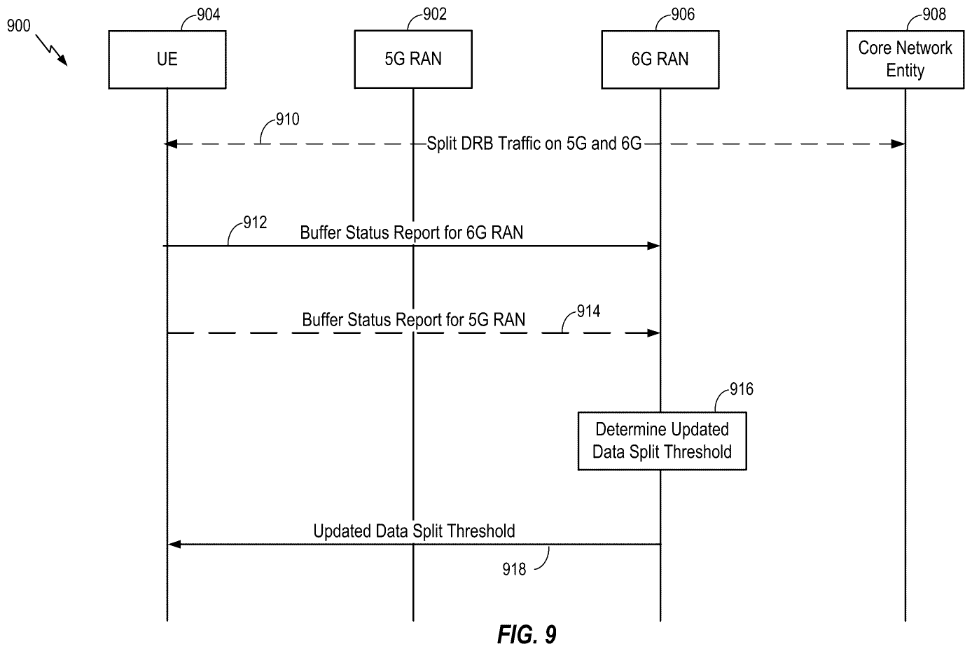

FIG. 9 depicts a process flow 900 for communications in a network between a 5G RAN 902, a UE 904, a 6G RAN 906, and a core network entity 908. In some aspects, the 5G RAN 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and 5G RAN 902 may be another type of network entity or network node, such as those described herein. Note that any operations or signaling illustrated with dashed lines may indicate that that operation or signaling is an optional or alternative example.

At 910, UE 904 is operating in a dual-stack operation mode in which it is simultaneously sending and receiving DRB traffic using 5G RAN 902 and 6G RAN 906. UE 904 has thus performed data splitting to communicate a first split of uplink data traffic including one or more QoS flows set up on 5G RAN 902, and one or more different QoS flows set up on 6G RAN 906. For example, UE 904 may be configured with an uplink data split threshold by 6G RAN 906 for splitting the uplink data traffic of an UL DRB in accordance with previously described techniques for performing process flow 800 of FIG. 8. As used herein, a “data split threshold” may include a predefined threshold for triggering data splitting of wireless communication data between two or more different RANs based on a predetermined ratio of uplink data traffic. In certain aspects, UE 904 may be configured with (in association with each accessible RAN) a data split threshold for a specific QoS flow, DRB, logical channel, or logical channel group. For example, for a given logical channel, UE 904 may be configured with a data split threshold indicating that 60% of uplink data traffic should be carried over 5G RAN 902, and 40% of uplink data traffic should be carried over 6G RAN 906. Accordingly, if data volume for the logical channel that is being carried over 5G RAN 902 exceeds 60%, then UE 904 may send a data session modification request to perform a data split to move one or more QoS flows from 5G RAN 902 to 6G RAN 906.

At 912, UE 904 sends, to 6G RAN 906, a buffer status report for 6G RAN 906. In certain aspects, in addition to information about the amount of data waiting in UE 904's transmission buffer that is waiting to be sent over to a given RAN, the BSR may further include additional information such as priority information, uplink resource information (e.g. whether additional uplink radio resources are needed), or information about how much data is in the buffer for respective logical channel groups of the UE. For example, UE 904 may perform BSR calculations after determining the first split of uplink data traffic between the 5G RAN 902 and the 6G RAN 906 based on a previously configured data split threshold.

At 914, in certain aspects, UE 904 may optionally provide 6G RAN 906 with a BSR for 5G RAN 902 which includes data volume waiting to be sent on 5G RAN 902. In certain aspects, UE 904 is configured to provide a BSR for data volume waiting to be sent using 5G RAN 902. The information in the BSR for 5G RAN 902 may be used by 6G RAN 906 to make a more accurate and informed determination regarding whether UE 904 should be configured with an updated data split threshold. In certain other aspects, UE 904 is not configured to provide a BSR for data volume waiting to be sent using 5G RAN 902, thereby reducing volume of signaling and power consumption at UE 904.

At 916, 6G RAN 906 may determine an updated data split threshold based on the received BSRs sent by UE 904. For example, UE 904 may be configured with an original data split threshold to split uplink data traffic by sending 50% of the uplink data traffic using 5G RAN 902, and 50% of the uplink data traffic using 6G RAN 906. 6G RAN 906 may then consider a first BSR indicating that there is 500 megabytes (MB) of data waiting to be sent on 6G RAN 906, and a second BSR indicating that there is only 100 MB of data waiting to be sent on 5G RAN 902. Accordingly, at 916, 6G RAN 906 may determine an updated data split threshold to dynamically adjust based on the received BSRs. For example, 6G RAN 906 may determine an appropriate updated data split threshold directing 70% of the uplink data traffic to 5G RAN 902, and 30% of the uplink data traffic to 6G RAN 906 to reduce congestion and increase efficient resource usage.

At 918, 6G RAN 906 sends, to UE 904, the updated data split threshold. In certain aspects, 6G RAN 906 may configure UE 904 with the updated data split threshold using RRC signaling. For example, UE 904 may send a RRC reconfiguration message including the updated data split threshold. In some examples, 6G RAN 906 sends the updated split threshold within a MAC CE.

By sending the buffer status report to 6G RAN 906 after performing a data split, UE 904 provides 6G RAN 906 with information to determine whether to reconfigure the UE with an updated data split threshold. UE 904 may then perform data splitting based on the updated data split threshold to ensure uplink data traffic is effectively split among available RANs, such as 5G RAN 902 and 6G RAN 906, thereby providing the technical benefit of improving resource management, reliability of connectivity, and wireless communication performance.

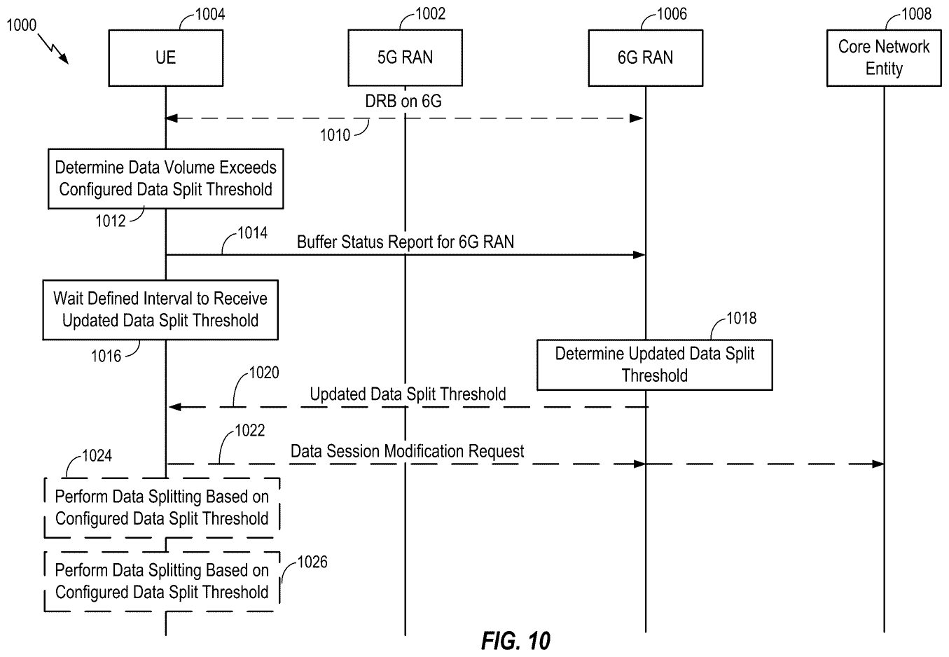

FIG. 10 depicts a process flow 1000 for communications in a network between a 5G RAN 1002, a UE 1004, a 6G RAN 1006, and a core network entity 1008. In some aspects, the 5G RAN 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and 5G RAN 1002 may be another type of network entity or network node, such as those described herein. Note that any operations or signaling illustrated with dashed lines may indicate that that operation or signaling is an optional or alternative example.

At 1010, UE 1004 is communicating using a DRB on 6G RAN 1006. UE 1004 may be configured with a data split threshold for causing the UE to perform a data split.

At 1012, UE 1004 determines that a data volume being communicated has exceeded the configured data split threshold. For example, UE 1004 may determine that the data volume for a given QoS flow, DRB, logical channel, or logical channel group is above the configured data split threshold, causing the UE to send an updated BSR before performing a data split. Accordingly, in certain aspects, UE 1004 determining that a data volume for a given QoS flow, DRB, logical channel, or logical channel group has exceeded a configured data split threshold functions as a trigger condition for sending a BSR.

At 1014, UE 1004 sends to 6G RAN 1006 a BSR including an amount of data waiting to be sent over 6G RAN 1006.

At 1016, UE 1004 waits for a defined interval to receive an updated data split threshold from 6G RAN 1006. In certain aspects, 6G RAN 1006 may configure UE 1004 with the defined interval. In certain aspects, 6G RAN 1006 may configure UE 1004 with a different defined interval for given QoS flows, DRBs, logical channels, or logical channel groups.

At 1018, 6G RAN 1006 determines an updated data split threshold, for example, based on the BSR sent by UE 1004 at 1014. 6G RAN 1006 may determine the updated data split threshold in a similar manner as described above in connection with 6G RAN 906 of FIG. 6.

At 1020, 6G RAN 1006 optionally sends the updated data split threshold to UE 1004. For example, if 6G RAN 1006 can accommodate additional data volume, it may provide an updated data split threshold to limit the tendency of the UE to activate the second connection involving 6G RAN 1006 thereby providing the technical benefit of reducing power consumption if the UE continues to communicate using only one connection. At certain times, 6G RAN 1006 may not send an updated data split threshold within the defined interval, for example, if 6G RAN is experiencing high network congestion or overload, poor link conditions or interference, or processing delays. At certain other times, 6G RAN 1006 may not send an updated data split threshold within the defined interval because of policy limitations. For example, network policies of 6G RAN 1006 may restrict the frequency of data split threshold updates under certain conditions, such as when energy efficiency or network stability are being prioritized.

At 1022, UE 1004 sends a data session modification request to perform data splitting.

At 1024, in some aspects, if UE 1004 does not receive an updated data split threshold within the defined interval, then UE 1004 performs data splitting based on the configured data split threshold.

Alternatively, at 1026, if UE 1004 receives an updated data split threshold from 6G RAN 1006 within the defined interval, then UE 1004 will perform data splitting based on the updated data split threshold. Accordingly, the information of the data session modification request (e.g. which QoS flows are to be sent to which RAN) is dependent upon whether the UE receives the updated data split threshold from 6G RAN 1006 within the defined interval.

By sending a buffer status report and then waiting for a defined interval to receive an updated data split threshold before performing a data split, UE 1004 enables 6G RAN 1006 to provide an updated data split threshold for causing the UE to determine whether to perform a data split based on the updated data split threshold. Receiving the updated data split threshold can limit the tendency for UE 1004 to perform data splitting when 6G RAN 1006 is able to accommodate additional data volume, thereby reducing power consumption by limiting the number of active RAN connections being used.

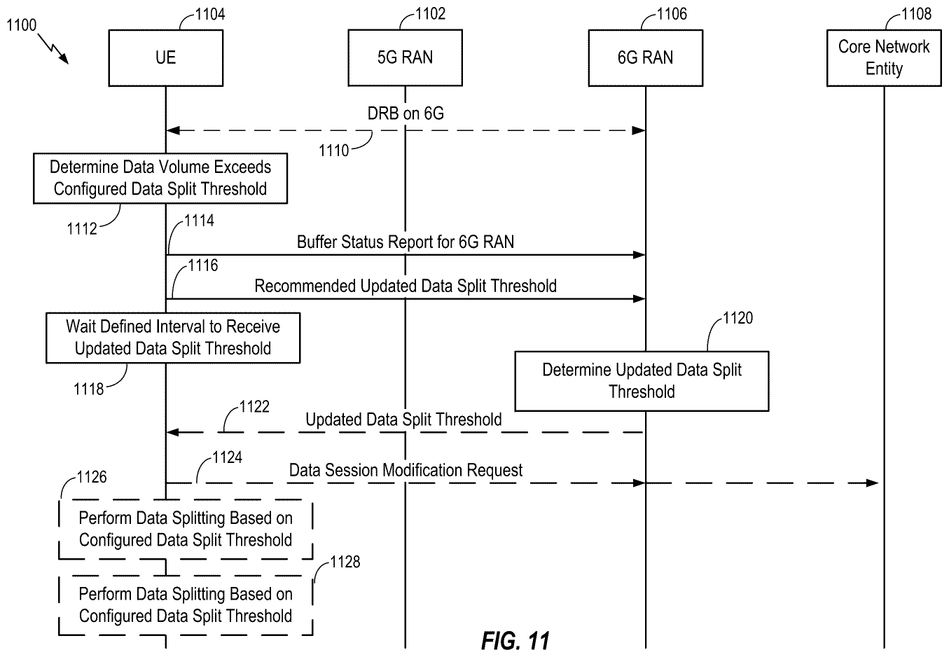

FIG. 11 depicts a process flow 1100 for communications in a network between a 5G RAN 1102, a UE 1104, a 6G RAN 1106, and a core network entity 1108. In some aspects, the 5G RAN 1102 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1104 may be an example of UE 104 depicted and described with respect to FIG. 1 or the UE 304 depicted and described with respect to FIG. 3. However, in other aspects, UE 1104 may be another type of wireless communications device and 5G RAN 1102 may be another type of network entity or network node, such as those described herein. Note that any operations or signaling illustrated with dashed lines may indicate that that operation or signaling is an optional or alternative example.

In certain aspects 1110-1114 and 1118-1124 of FIG. 11 are the same or similar as 1010-1014 and 1016-1022 of FIG. 10.

At 1116, UE 1104 may send, to 6G RAN 1106 a recommended updated data split threshold. In certain aspects, the recommended updated data split threshold may be associated with one of a quality of service (QoS) flow, a data radio bearer, a logical channel, or a logical channel group. The recommended updated data spilt threshold may be determined by UE 1104 based on BSR calculations performed for sending a BSR (e.g. at 1114) to 6G RAN 1106. For example, UE 1104 may be configured with a data split threshold for communicating 50% of uplink data traffic for a QoS flow over 6G RAN 1106, and 50% of uplink data traffic for the QoS flow over 5G RAN 1102. UE 1104 may send a BSR for an example QoS flow based on BSR calculations that indicate a volume of data in the buffer indicating that 6G RAN 1106 is underutilized. The BSR calculations may further indicate that the example QoS flow has strict latency requirements. Based on the BSR calculations, at 1116, UE 1104 may then send, to 6G RAN 1106, a recommended updated data split threshold for limiting data splitting. For example, UE 1104 may send, to 6G RAN 1106, a recommended updated data split threshold to communicate 70% of uplink data traffic over 6G RAN 1106 and 30% of uplink data traffic over 5G RAN 1102, thereby providing the technical benefit of increasing efficiency in resource utilization at 6G RAN 1106, maintaining reduced power consumption by limiting the use of multiple connections, and ensuring strict latency requirements are met by prioritizing use of the 6G RAN 1106 having the lowest delay.

At 1120, 6G RAN 1106 then determines an updated data split threshold based on the received recommended updated data split threshold. For example, 6G RAN 1106 may evaluate network conditions (e.g. available bandwidth, network congestion, signal quality, etc.), consider QoS flow requirements, and consider network policies for guiding a threshold determination. 6G RAN 1106 then calculates an updated data split threshold for allocating uplink data traffic among available RANs, such as 5G RAN 1102 and 6G RAN 1106.

At 1122, 6G RAN 1106 may optionally reconfigure UE 1104 with the updated data split threshold. As previously described, UE will wait for a defined interval to be reconfigured with an updated data split threshold before performing data splitting to move on or more QoS flows among links. At certain times, 6G RAN 1106 may not send an updated data split threshold within the defined interval, for example, if 6G RAN 1106 is experiencing high network congestion or overload, poor link conditions or interference, or processing delays. At certain other times, 6G RAN 1106 may not send an updated data split threshold within the defined interval because of policy limitations. For example, network policies of 6G RAN 1106 may restrict the frequency of data split threshold updates under certain conditions, such as when energy efficiency or network stability are being prioritized.

Note that the process flows illustrated in FIGS. 6-11 are described herein to facilitate an understanding of techniques for enabling data splitting in a multi-generation wireless communication systems], and aspects of the present disclosure may be performed in various manners via alternative or additional signaling and/or operations. In certain aspects, the operations and/or signaling of FIGS. 6-11 may occur in an order different from that described or depicted, and various actions, operations, and/or signaling may be added, omitted, or combined.

### Example Operations of a User Equipment

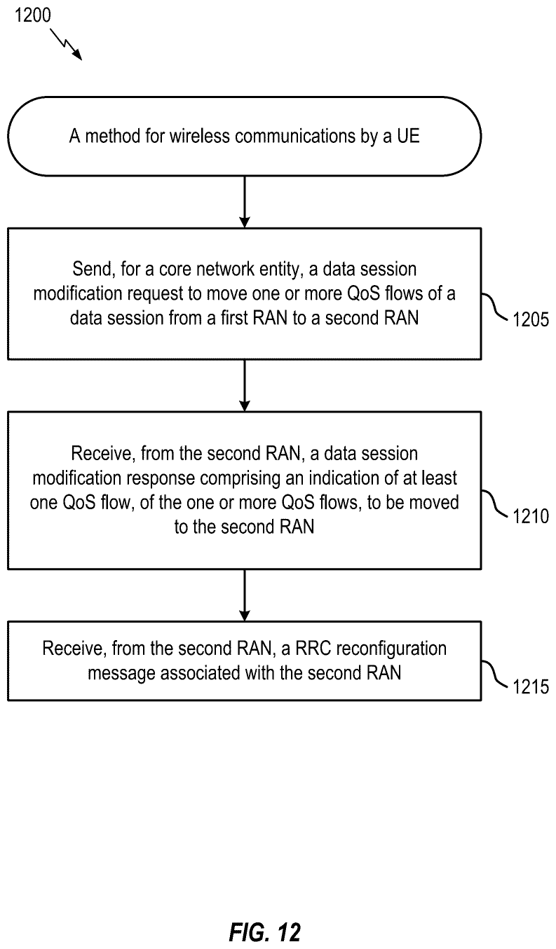

FIG. 12 shows a method 1200 for wireless communications by an apparatus, such as UE 104 of FIG. 1 or UE 304 of FIG. 3.

Method 1200 begins at block 1205 with sending, for a core network entity, a data session modification request to move one or more QoS flows of a data session from a first RAN to a second RAN. For example, the sending of the data session modification request could correspond to 612 and 614 of FIG. 6.

Method 1200 then proceeds to block 1210 with receiving, from the second RAN, a data session modification response comprising an indication of at least one QoS flow, of the one or more QoS flows, to be moved to the second RAN. For example, the receiving of the data session modification response could correspond to 624 of FIG. 6.

Method 1200 then proceeds to block 1215 with receiving, from the second RAN, a RRC reconfiguration message associated with the second RAN. For example the receiving of the RRC reconfiguration message could correspond to 626 of FIG. 6. Method 1200 may provide the technical benefit of allowing the UE to perform data splitting by communicating a list of accepted QoS flows via the second RAN, which in-turn may provide the benefit of increased throughput and/or reliability, and reduced latency.

In some aspects, method 1200 further includes initiating the data session with the second RAN based on the RRC reconfiguration message.

In some aspects, method 1200 further includes sending data associated with the at least one QoS flow to the second RAN.

In some aspects, method 1200 further includes maintaining a PDU session with the first RAN, wherein the PDU session is associated with the one or more QoS flows, wherein the first RAN comprises a 5G RAN.

In some aspects, the UE is configured for a dual-stack operation mode.

In some aspects, method 1200 further includes sending the data session modification request based on a user plane measurement of a first RAN link for sending data between the UE and the first RAN, and a user plane measurement of a second RAN link for sending data between the UE and the second RAN.

In some aspects, block 1205 includes sending the data session modification request based on an access traffic steering, switching, and splitting rule for accessing the first RAN and the second RAN.

In some aspects, method 1200 further includes sending the data session modification request to move the at least one QoS flow based on the UE communicating the one or more QoS flows via an application having a capability to access the first RAN and the second RAN.

In some aspects, method 1200 further includes sending the data session modification request to move the one or more QoS flows based on a rule indicating a preconfigured distribution of traffic between the first RAN and the second RAN.

In some aspects, block 1205 includes sending the data session modification request based on one or more QoS parameters of the one or more QoS flows.

In some aspects, method 1200 further includes sending the data session modification request to the second RAN.

In some aspects, the data session modification request comprises a PDU session identifier.

In some aspects, the data session modification request comprises a QoS parameter for satisfying a minimum QoS requirement corresponding to a respective QoS flow of the one or more QoS flows.

In some aspects, method 1200 further includes maintaining a DRB with the first RAN, the DRB associated with the one or more QoS flows, wherein the first RAN comprises a 5G RAN.

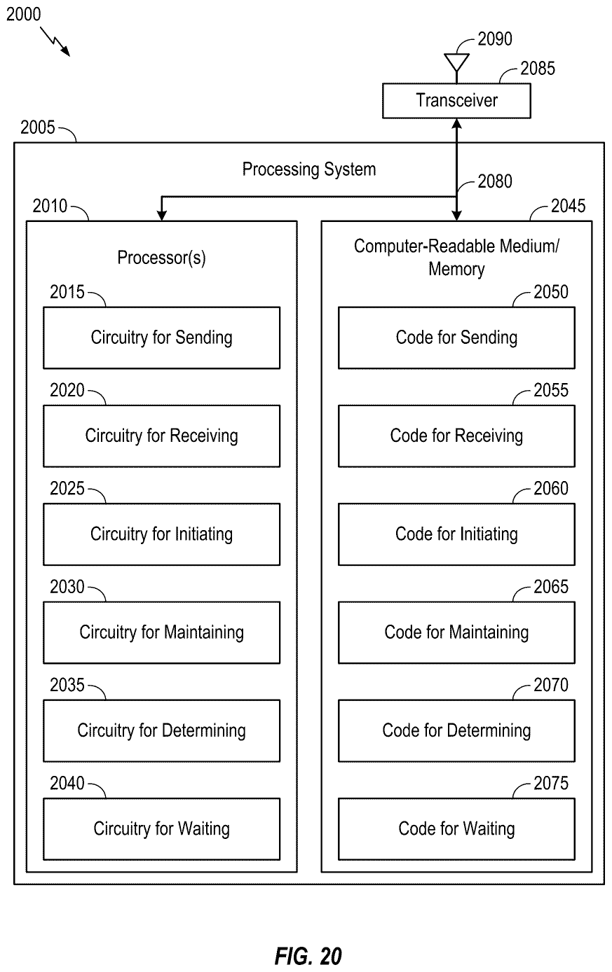

In some aspect, method 1200, or any aspect related to it, may be performed by an apparatus, such as communications device 2000 of FIG. 20, which includes various components operable, configured, or adapted to perform the method 1200. Communications device 2000 is described below in further detail.

Note that FIG. 12 is just one example of a method, and other methods including fewer, additional, or alternative operations are possible consistent with this disclosure.

### Example Operations of a Core Network Entity

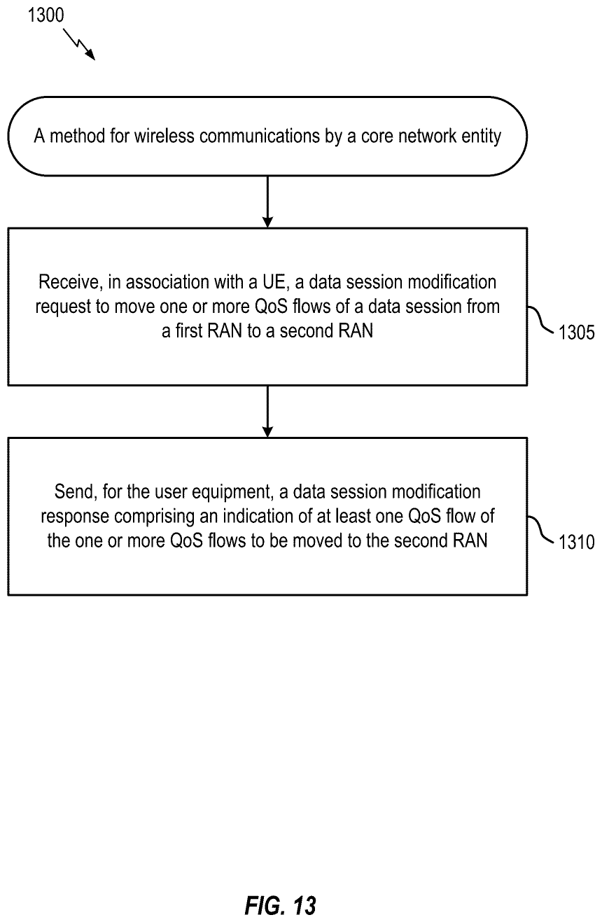

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with receiving, in association with a UE, a data session modification request to move one or more QoS flows of a data session from a first RAN to a second RAN. For example, the receiving of the data session modification request could correspond to 614 of FIG. 6.

Method 1300 then proceeds to block 1310 with sending, for the user equipment, a data session modification response comprising an indication of at least one QoS flow of the one or more QoS flows to be moved to the second RAN. For example, the sending of the data session modification response could correspond to 622 of FIG. 6. Method 1300 may provide the technical benefit of allowing the UE to perform data splitting by communicating a list of accepted QoS flows via the second RAN, which in-turn may provide the benefit of increased throughput and/or reliability, and reduced latency.

In certain aspects, method 1300 further includes determining the at least one of the QoS flows to be moved to the second RAN based on one or more policies of the core network entity.

In some aspects, the data session modification request comprises a PDU session identifier.

In some aspects, the data session modification request comprises a QoS parameter for satisfying a minimum QoS requirement corresponding to a respective QoS flow of the one or more QoS flows.

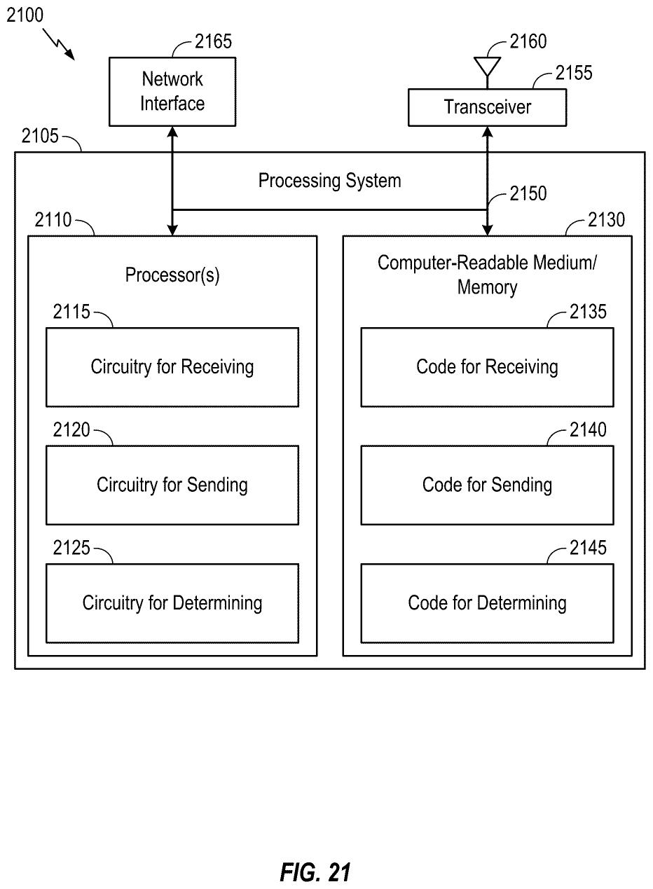

In some aspect, method 1300, or any aspect related to it, may be performed by an apparatus, such as communications device 2100 of FIG. 21, which includes various components operable, configured, or adapted to perform the method 1300. Communications device 2100 is described below in further detail.

Note that FIG. 13 is just one example of a method, and other methods including fewer, additional, or alternative operations are possible consistent with this disclosure.

### Example Operations of a Network Entity

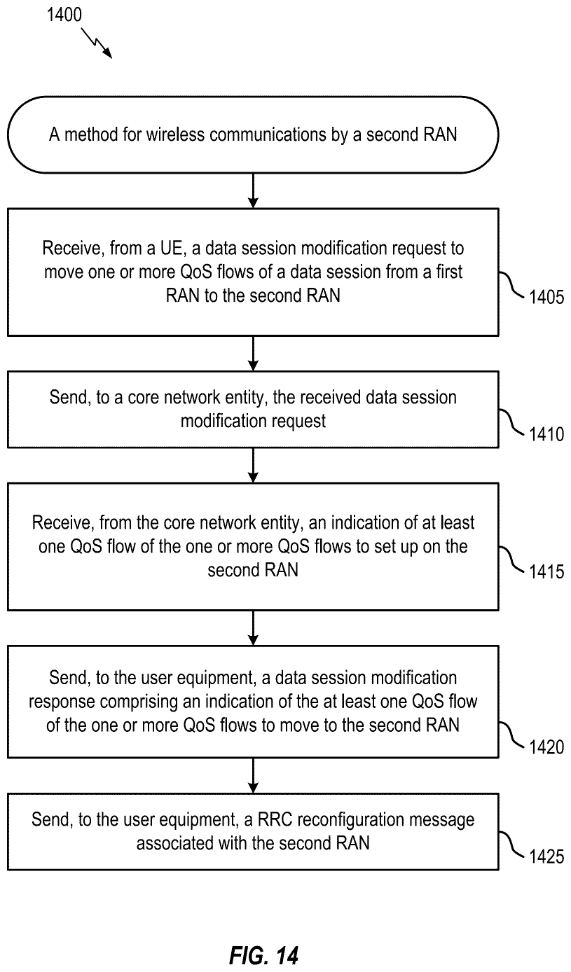

FIG. 14 shows a method 1400 for wireless communications by an apparatus, such as BS 102 of FIG. 1, a first network entity 300 or second network entity 302 of FIG. 3, or a disaggregated base station as discussed with respect to FIG. 2.

Method 1400 begins at block 1405 with receiving, from a UE, a data session modification request to move one or more QoS flows of a data session from a first RAN to the second RAN. For example, the receiving of the data session modification request could correspond to 612 of FIG. 6.

Method 1400 then proceeds to block 1410 with sending, to a core network entity, the received data session modification request. For example, the sending of the data session modification request could correspond to 614 of FIG. 6.

Method 1400 then proceeds to block 1415 with receiving, from the core network entity, an indication of at least one QoS flow of the one or more QoS flows to set up on the second RAN. For example, the receiving of the indication of the at least one QoS flow of the one or more QoS flows to set up on the second RAN could correspond to 618 of FIG. 6.

Method 1400 then proceeds to block 1420 with sending, to the user equipment, a data session modification response comprising an indication of the at least one QoS flow of the one or more QoS flows to move to the second RAN. For example, the sending of the data session modification response could correspond to 622 of FIG. 6.

Method 1400 then proceeds to block 1425 with sending, to the user equipment, a RRC reconfiguration message associated with the second RAN. For example, the sending of the RRC reconfiguration message could correspond to 624 of FIG. 6. Method 1400 may provide the technical benefit of allowing the UE to perform data splitting by communicating a list of accepted QoS flows via the second RAN, which in-turn may provide the benefit of increased throughput and/or reliability, and reduced latency.

In some aspects, the data session modification request comprises a PDU session identifier.

In some aspects, the data session modification request comprises a QoS parameter for satisfying a minimum QoS requirement corresponding to a respective QoS flow of the one or more QoS flows.

In certain aspects, method 1400 further includes performing an admission control to determine a list of accepted QoS flows.

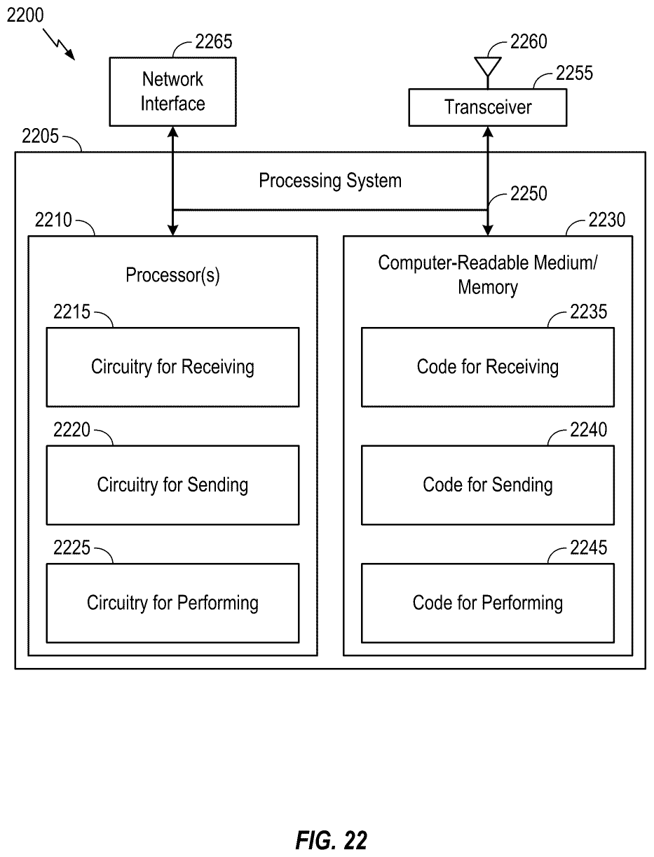

In some aspect, method 1400, or any aspect related to it, may be performed by an apparatus, such as communications device 2200 of FIG. 22, which includes various components operable, configured, or adapted to perform the method 1400. Communications device 2200 is described below in further detail.

Note that FIG. 14 is just one example of a method, and other methods including fewer, additional, or alternative operations are possible consistent with this disclosure.

### Example Operations of a User Equipment

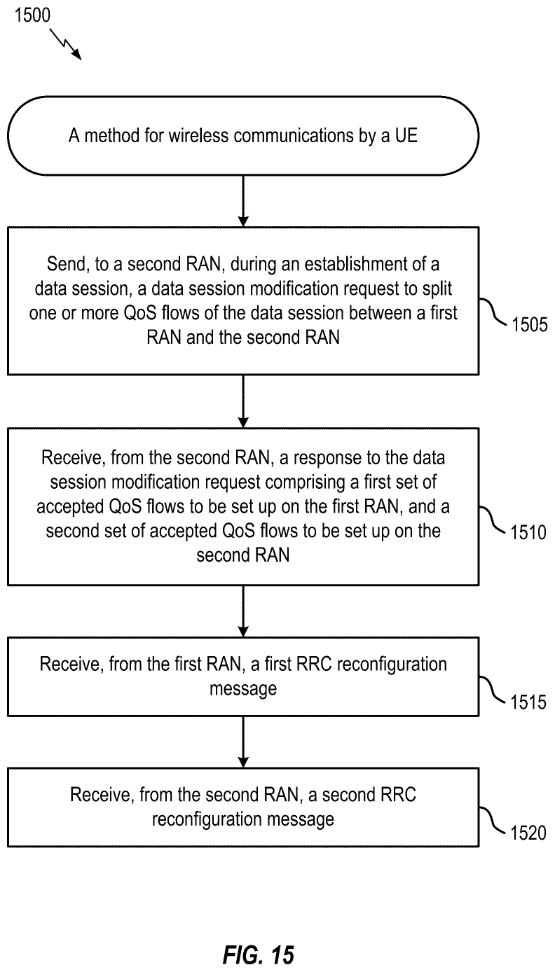

FIG. 15 shows a method 1500 for wireless communications by an apparatus, such as UE 104 of FIG. 1 or UE 304 of FIG. 3.

Method 1500 begins at block 1505 with sending, to a second RAN, during an establishment of a data session, a data session modification request to split one or more QoS flows of the data session between a first RAN and the second RAN. For example, the sending of the data session modification request could correspond to 712 of FIG. 7.

Method 1500 then proceeds to block 1510 with receiving, from the second RAN, a response to the data session modification request comprising a first set of accepted QoS flows to be set up on the first RAN, and a second set of accepted QoS flows to be set up on the second RAN. For example, receiving of the response to the data session modification request could correspond to 728 of FIG. 7.

Method 1500 then proceeds to block 1515 with receiving, from the first RAN, a first RRC reconfiguration message. For example, the receiving of the first RRC reconfiguration message from the first RAN could correspond to 732 of FIG. 7.

Method 1500 then proceeds to block 1520 with receiving, from the second RAN, a second RRC reconfiguration message. For example, the receiving of the second RRC reconfiguration message could correspond to 730 of FIG. 7. Method 1500 may provide the technical benefit of allowing the UE to perform data splitting during initial establishment of a data session by utilizing multiple available RANs at the outset of a data session. Performing data splitting during an initial establishment of a data session further distributes data traffic more efficiently, thereby providing the technical benefits of optimizing resource utilization between two RANs by balancing data loads, further providing the technical benefit of enhancing overall network performance and reducing the likelihood of congestion on any single link.

In some aspects, method 1500 further includes determining a split of the one or more QoS flows between the first RAN and the second RAN based on a first user plane measurement of a first RAN link for sending data between the UE and the first RAN, and a second user plane measurement of a second RAN link for sending data between the UE and the second RAN.

In some aspects, method 1500 further includes determining a split of the one or more QoS flows between the first RAN and the second RAN based on an access traffic steering, switching, and splitting rule for accessing the first RAN and the second RAN.

In some aspects, block 1505 includes sending the data session modification request based on one or more QoS parameters of the one or more QoS flows.

In some aspects, method 1500 further includes sending the data session modification request to the second RAN.

In some aspects, the data session modification request comprises a list of one or more QoS flow identifiers for the first RAN.

In some aspects, the data session modification request comprises a list of one or more QoS flow identifiers for the second RAN.

In some aspects, the data session modification request comprises one or more data session identifiers for establishing the data session.

In some aspects, method 1500 further includes sending, for a core network entity, a QoS parameter for satisfying a minimum QoS requirement corresponding to a respective QoS flow of the one or more QoS flows.

In some aspect, method 1500, or any aspect related to it, may be performed by an apparatus, such as communications device 2000 of FIG. 20, which includes various components operable, configured, or adapted to perform the method 1500. Communications device 2000 is described below in further detail.

Note that FIG. 15 is just one example of a method, and other methods including fewer, additional, or alternative operations are possible consistent with this disclosure.

### Example Operations of a Core Network Entity

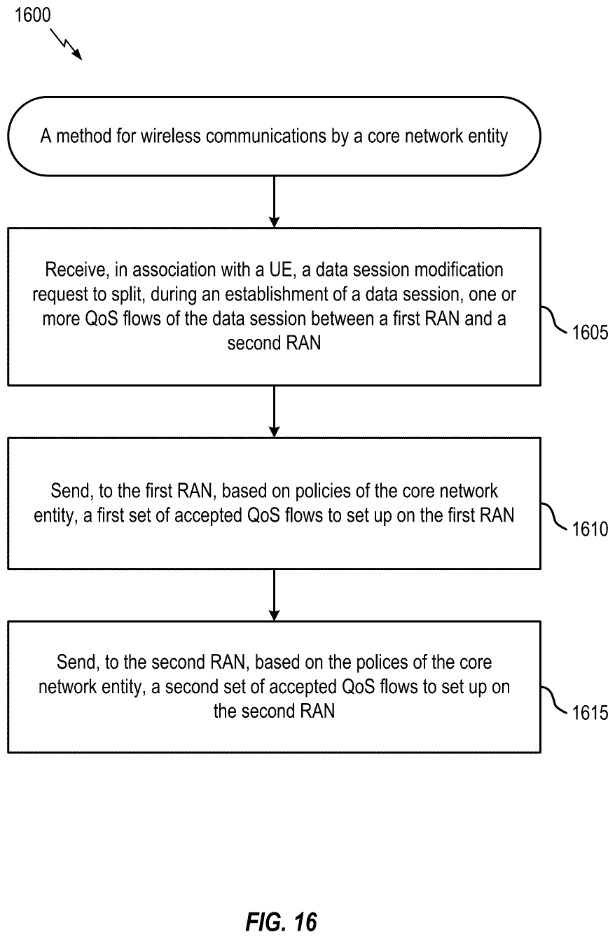

FIG. 16 shows a method 1600 for wireless communications by an apparatus, such as BS 102 of FIG. 1, a first network entity 300 or second network entity 302 of FIG. 3, or a disaggregated base station as discussed with respect to FIG. 2.

Method 1600 begins at block 1605 with receiving, in association with a UE, a data session modification request to split, during an establishment of a data session, one or more QoS flows of the data session between a first RAN and a second RAN. For example, the receiving of the data session modification request could correspond to 714 of FIG. 7.

Method 1600 then proceeds to block 1610 with sending, to the first RAN, based on policies of the core network entity, a first set of accepted QoS flows to set up on the first RAN. For example, the sending of the first set of accepted QoS flows could correspond to 720 of FIG. 7.

Method 1600 then proceeds to block 1615 with sending, to the second RAN, based on the polices of the core network entity, a second set of accepted QoS flows to set up on the second RAN. For example, the sending of the second set of accepted QoS flows could correspond to 718 of FIG. 7. Method 1600 may provide the technical benefit of allowing the UE to perform data splitting during initial establishment of a data session by utilizing multiple available RANs at the outset of a data session. Performing data splitting during an initial establishment of a data session further distributes data traffic more efficiently, thereby providing the technical benefits of optimizing resource utilization between two RANs by balancing data loads, further providing the technical benefit of enhancing overall network performance and reducing the likelihood of congestion on any single link.

In certain aspects, method 1600 further includes receiving the data session modification request from the second RAN.

In some aspects, the received data session modification request comprises a first list of one or more QoS flow identifiers to be set up on the first RAN, and a second list of one or more QoS flow identifiers to be set up on the second RAN.

In some aspects, the data session modification request comprises one or more data session identifiers for establishing the data session.

In certain aspects, method 1600 further includes receiving, in association with the UE, a QoS parameter for satisfying a minimum QoS requirement corresponding to a respective QoS flow of the one or more QoS flows.

In some aspect, method 1600, or any aspect related to it, may be performed by an apparatus, such as communications device 2100 of FIG. 21, which includes various components operable, configured, or adapted to perform the method 1600. Communications device 2100 is described below in further detail.

Note that FIG. 16 is just one example of a method, and other methods including fewer, additional, or alternative operations are possible consistent with this disclosure.

### Example Operations of a Network Entity

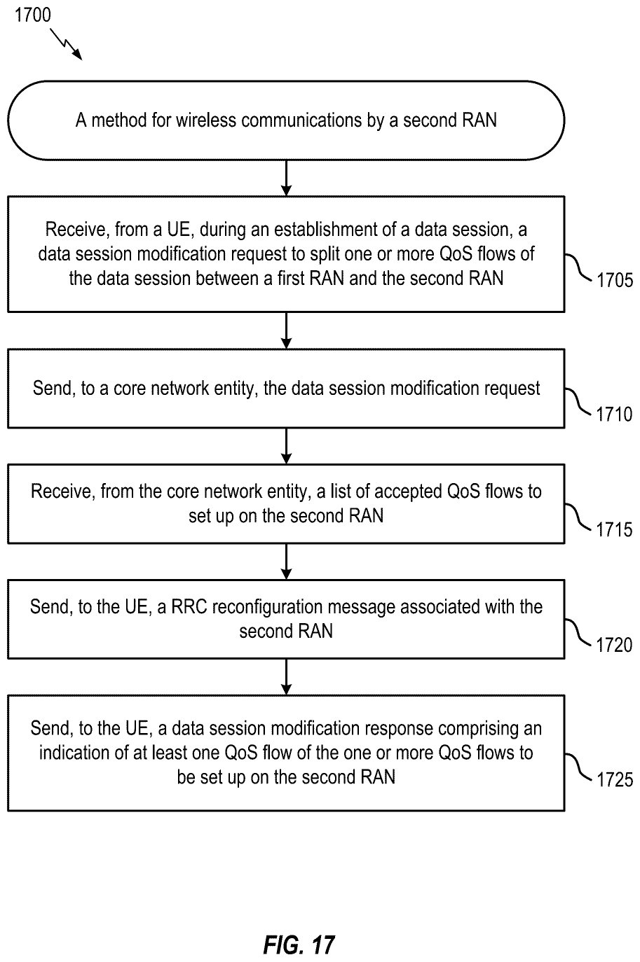

FIG. 17 shows a method 1700 for wireless communications by an apparatus, such as BS 102 of FIG. 1, a first network entity 300 or second network entity 302 of FIG. 3, or a disaggregated base station as discussed with respect to FIG. 2.

Method 1700 begins at block 1705 with receiving, from a UE, during an establishment of a data session, a data session modification request to split one or more QoS flows of the data session between a first RAN and the second RAN. For example, the receiving of the data session modification request could correspond to 712 of FIG. 7.

Method 1700 then proceeds to block 1710 with sending, to a core network entity, the data session modification request. For example, the sending of the data session modification request could correspond to 714 of FIG. 7.

Method 1700 then proceeds to block 1715 with receiving, from the core network entity, a list of accepted QoS flows to set up on the second RAN. For example, the receiving of the list of accepted QoS flows could correspond to 718 of FIG. 7.

Method 1700 then proceeds to block 1720 with sending, to the UE, a RRC reconfiguration message associated with the second RAN. For example, sending of the RRC reconfiguration message could correspond to 730 of FIG. 7.

Method 1700 then proceeds to block 1725 with sending, to the UE, a data session modification response comprising an indication of at least one QoS flow of the one or more QoS flows to be set up on the second RAN. For example, the sending of the data session modification response could correspond to 728 of FIG. 7. Method 1700 may provide the technical benefit of allowing the UE to perform data splitting during initial establishment of a data session by utilizing multiple available RANs at the outset of a data session. Performing data splitting during an initial establishment of a data session further distributes data traffic more efficiently, thereby providing the technical benefits of optimizing resource utilization between two RANs by balancing data loads, further providing the technical benefit of enhancing overall network performance and reducing the likelihood of congestion on any single link.

In some aspects, the data session modification request comprises a list of one or more QoS flow identifiers to be set up on the first RAN.

In some aspects, the data session modification request comprises a list of one or more QoS flow identifiers to be set up on the second RAN.

In some aspects, the data session modification request comprises a QoS parameter for satisfying a minimum QoS requirement corresponding to a respective QoS flow of the one or more QoS flows.

In some aspects, block 1725 includes performing an admission control to determine a list of accepted QoS flows to set up on the second RAN.

In some aspect, method 1700, or any aspect related to it, may be performed by an apparatus, such as communications device 2200 of FIG. 22, which includes various components operable, configured, or adapted to perform the method 1700. Communications device 2200 is described below in further detail.

Note that FIG. 17 is just one example of a method, and other methods including fewer, additional, or alternative operations are possible consistent with this disclosure.

### Example Operations of a User Equipment

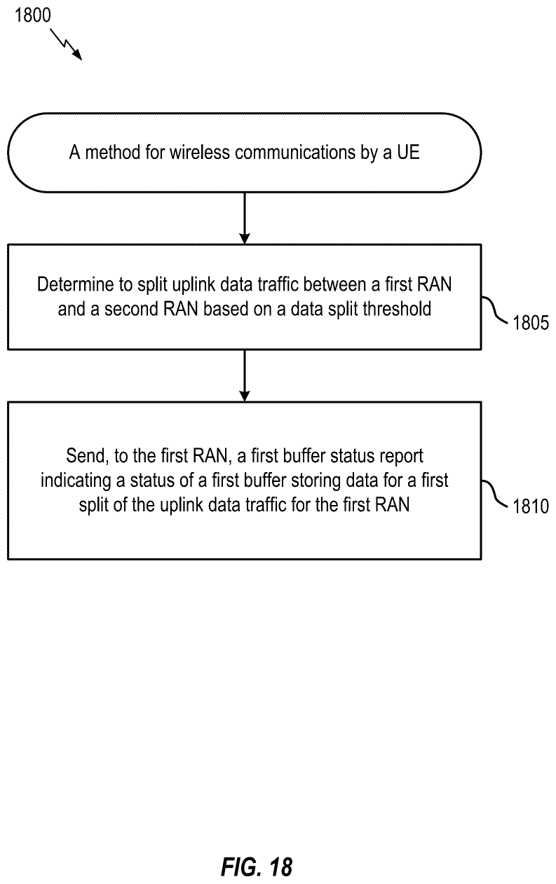

FIG. 18 shows a method 1800 for wireless communications by an apparatus, such as UE 104 of FIG. 1 or UE 304 of FIG. 3.

Method 1800 begins at block 1805 with determining to split uplink data traffic between a first RAN and a second RAN based on a data split threshold. For example, the split uplink data traffic could correspond to 910 of FIG. 9.

Method 1800 then proceeds to block 1810 with sending, to the first RAN, a first buffer status report indicating a status of a first buffer storing data for a first split of the uplink data traffic for the first RAN. For example, the sending of the first buffer status report could correspond to 912 of FIG. 9. Method 1800 enables the UE to send a buffer status report to cause the first RAN to reconfigure the UE with an updated data split threshold, providing the technical benefit of causing the UE to determine updated splits of data based on the updated data split threshold, thereby providing the benefit of improving resource management, reliability of connectivity, and wireless communication performance between the UE and associated RANs.

In some aspects, method 1800 further includes receiving, from the first RAN, an updated data split threshold.

In some aspects, method 1800 further includes determining an updated first split of the uplink data traffic for the first RAN based on the updated data split threshold.

In some aspects, method 1800 further includes sending, to the first RAN, the updated first split of the uplink data traffic.

In some aspects, method 1800 further includes sending, to the first RAN, a second buffer status report indicating a status of a second buffer storing data for a second split of the uplink data traffic for the second RAN.

In some aspects, method 1800 further includes sending, to the first RAN, a recommended updated data split threshold.

In some aspects, the updated data split threshold is associated with one of a QoS flow, a data radio bearer, a logical channel, or a logical channel group.

In some aspects, method 1800 further includes waiting for a defined interval and send, to the first RAN, after the defined interval without receiving an updated data split threshold, the first split of the uplink data traffic based on the data split threshold.

In some aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative operations are possible consistent with this disclosure.

### Example Operations of a Network Entity

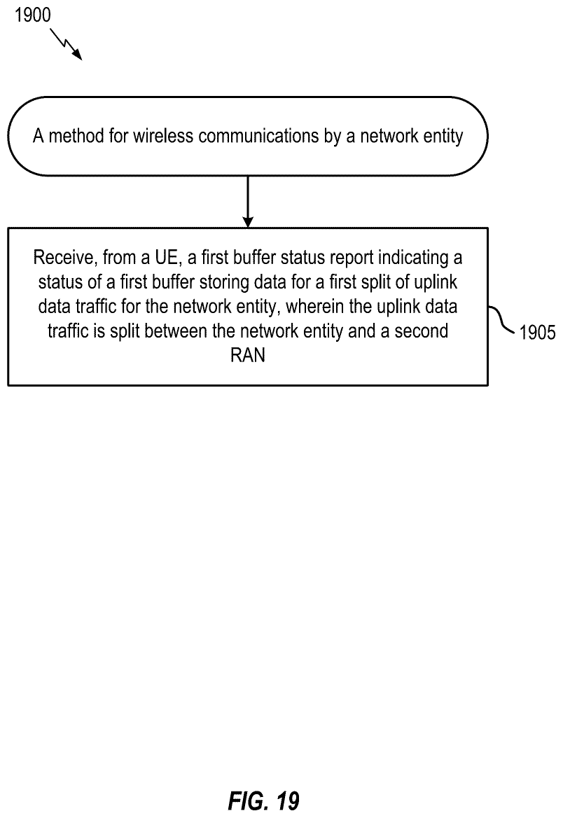

FIG. 19 shows a method 1900 for wireless communications by an apparatus, such as BS 102 of FIG. 1, a first network entity 300 or second network entity 302 of FIG. 3, or a disaggregated base station as discussed with respect to FIG. 2.

Method 1900 begins at block 1905 with receiving, from a UE, a first buffer status report indicating a status of a first buffer storing data for a first split of uplink data traffic for the network entity, wherein the uplink data traffic is split between the network entity and a second RAN. For example, the receiving of the first buffer status report could correspond to 1014 of FIG. 10. Method 1900 enables the UE to send a buffer status report to cause the network entity to reconfigure the UE with an updated data split threshold, providing the technical benefit of causing the UE to determine updated splits of data based on the updated data split threshold, thereby providing the benefit of improving resource management, reliability of connectivity, and wireless communication performance between the UE and associated network entities.

In certain aspects, method 1900 further includes sending, to the UE, an updated data split threshold.

In certain aspects, method 1900 further includes receiving, from the UE, an updated first split of the uplink data traffic.

In certain aspects, method 1900 further includes receiving, from the UE, a second buffer status report indicating a status of a second buffer storing data for a second split of the uplink data traffic for the second RAN.

In certain aspects, method 1900 further includes receiving, from the UE, a recommended updated data split threshold.

In some aspects, the updated data split threshold is associated with one of a QoS flow, a data radio bearer, a logical channel, or a logical channel group.

In certain aspects, method 1900 further includes sending, to the UE, within a defined interval, an updated data split threshold.

In certain aspects, method 1900 further includes receiving, from the UE, a second split of the uplink data traffic based on the updated data split threshold.

In certain aspects, method 1900 further includes receiving, from the UE, after a defined interval, the first split of the uplink data traffic based on a data split threshold.

In some aspect, method 1900, or any aspect related to it, may be performed by an apparatus, such as communications device 2200 of FIG. 22, which includes various components operable, configured, or adapted to perform the method 1900. Communications device 2200 is described below in further detail.

Note that FIG. 19 is just one example of a method, and other methods including fewer, additional, or alternative operations are possible consistent with this disclosure.

### Example Communications Devices

FIG. 20 depicts aspects of an example communications device 2000 configured for wireless communications. In some aspects, communications device 2000 is a user equipment, such as UE 104 described above with respect to FIG. 1 or UE 304 described with respect to FIG. 3.

The communications device 2000 includes a processing system 2005 coupled to a transceiver 2085 (e.g., a transmitter and/or a receiver). The transceiver 2085 is configured to transmit and receive signals for the communications device 2000 via an antenna 2090, such as the various signals as described herein. The processing system 2005 may be configured to perform processing functions for the communications device 2000, including processing signals received and/or to be transmitted by the communications device 2000.

The processing system 2005 includes one or more processors 2010 and a computer-readable medium/memory 2045. In various aspects, the one or more processors 2010 may be representative of the one or more processors 318 described with respect to FIG. 3. The one or more processors 2010 are coupled to a computer-readable medium/memory 2045 via a bus 2080. In some aspects, the computer-readable medium/memory 2045 may be representative of the one or more memories 320 described with respect to FIG. 3. The computer-readable medium/memory 2045 is a non-transitory computer-readable medium/memory. In certain aspects, the computer-readable medium/memory 2045 is configured to store instructions (e.g., computer-executable code), that when executed by the one or more processors 2010, cause the one or more processors 2010 to perform the method 1200 described with respect to FIG. 12, or any aspect related to it, including any operations described in relation to FIG. 12; the method 1500 described with respect to FIG. 15, or any aspect related to it, including any operations described in relation to FIG. 15; and the method 1800 described with respect to FIG. 18, or any aspect related to it, including any operations described in relation to FIG. 18. Note that reference to a processor performing a function of communications device 2000 may include one or more processors performing that function of communications device 2000, such as in a distributed fashion.

In the depicted example, computer-readable medium/memory 2045 stores code (e.g., executable instructions), including code for sending 2050, code for receiving 2055, code for initiating 2060, code for maintaining 2065, code for determining 2070, and code for waiting 2075. Processing of the code 2050-2075 may enable and cause the communications device 2000 to perform the method 1200 described with respect to FIG. 12, or any aspect related to it; the method 1500 described with respect to FIG. 15, or any aspect related to it; and the method 1800 described with respect to FIG. 18, or any aspect related to it.

The one or more processors 2010 include circuitry configured to implement (e.g., execute) the code stored in the computer-readable medium/memory 2045, including circuitry for sending 2015, circuitry for receiving 2020, circuitry for initiating 2025, circuitry for maintaining 2030, circuitry for determining 2035, and circuitry for waiting 2040. Processing with circuitry 2015-2040 may enable and cause the communications device 2000 to perform the method 1200 described with respect to FIG. 12, or any aspect related to it; the method 1500 described with respect to FIG. 15, or any aspect related to it; and the method 1800 described with respect to FIG. 18, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 2085 and/or antenna 2090 of the communications device 2000 in FIG. 20, and/or one or more processors 2010 of the communications device 2000 in FIG. 20. Means for communicating, receiving or obtaining may include the one or more transceivers 324, one or more antennas 322, and/or processing system 316 of the UE 304 illustrated in FIG. 3, transceiver 2085 and/or antenna 2090 of the communications device 2000 in FIG. 20, and/or one or more processors 2010 of the communications device 2000 in FIG. 20.

FIG. 21 depicts aspects of an example communications device configured for wireless communications. In some aspects, communications device 2100 is a network entity, such as BS 102 of FIG. 1, first network entity 300 or second network entity 302 of FIG. 3, or a disaggregated base station as discussed with respect to FIG. 2.

The communications device 2100 includes a processing system 2105 coupled to a transceiver 2155 (e.g., a transmitter and/or a receiver) and/or a network interface 2165. The transceiver 2155 is configured to transmit and receive signals for the communications device 2100 via an antenna 2160, such as the various signals as described herein. The network interface 2165 is configured to obtain and send signals for the communications device 2100 via communications link(s), such as a backhaul link, midhaul link, and/or fronthaul link as described herein, such as with respect to FIG. 2. The processing system 2105 may be configured to perform processing functions for the communications device 2100, including processing signals received and/or to be transmitted by the communications device 2100.

The processing system 2105 includes one or more processors 2110 and a computer-readable medium/memory 2130. In various aspects, one or more processors 2110 may be representative of the one or more processors 308, as described with respect to FIG. 3. The one or more processors 2110 are coupled to the computer-readable medium/memory 2130 via a bus 2150. In certain aspects, the computer-readable medium/memory 2130 is configured to store instructions (e.g., computer-executable code), including code 2135-2145, that when executed by the one or more processors 2110, cause the one or more processors 2110 to perform the method 1300 described with respect to FIG. 13, or any aspect related to it, including any operations described in relation to FIG. 13; and the method 1600 described with respect to FIG. 16, or any aspect related to it, including any operations described in relation to FIG. 16. The computer-readable medium/memory 2130 is a non-transitory computer-readable medium/memory. Note that reference to a processor of communications device 2100 performing a function may include one or more processors of communications device 2100 performing that function, such as in a distributed fashion.

In the depicted example, the computer-readable medium/memory 2130 stores code (e.g., executable instructions), including code for receiving 2135, code for sending 2140, and code for determining 2145. Processing of the code 2135-2145 may enable and cause the communications device 2100 to perform the method 1300 described with respect to FIG. 13, or any aspect related to it; and the method 1600 described with respect to FIG. 16, or any aspect related to it.

The one or more processors 2110 include circuitry configured to implement (e.g., execute) the code stored in the computer-readable medium/memory 2130, including circuitry for receiving 2115, circuitry for sending 2120, and circuitry for determining 2125. Processing with circuitry 2115-2125 may enable and cause the communications device 2100 to perform the method 1300 described with respect to FIG. 13, or any aspect related to it; and the method 1600 described with respect to FIG. 16, or any aspect related to it.

Various components of the communications device 2100 may provide means for performing the method 1300 described with respect to FIG. 13, or any aspect related to it; and the method 1600 described with respect to FIG. 16, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 2155, antenna 2160, and/or network interface 2165 of the communications device 2100 in FIG. 21, and/or one or more processors 2110 of the communications device 2100 in FIG. 21. Means for communicating, receiving or obtaining may include the one or more transceivers 312, one or more antennas 314, and/or processing system 306 of the first network entity 300 or the second network entity 302 illustrated in FIG. 3, transceiver 2155, antenna 2160, and/or network interface 2165 of the communications device 2100 in FIG. 21, and/or one or more processors 2110 of the communications device 2100 in FIG. 21.

FIG. 22 depicts aspects of an example communications device configured for wireless communications. In some aspects, communications device 2200 is a network entity, such as BS 102 of FIG. 1, first network entity 300 or second network entity 302 of FIG. 3, or a disaggregated base station as discussed with respect to FIG. 2.

The communications device 2200 includes a processing system 2205 coupled to a transceiver 2255 (e.g., a transmitter and/or a receiver) and/or a network interface 2265. The transceiver 2255 is configured to transmit and receive signals for the communications device 2200 via an antenna 2260, such as the various signals as described herein. The network interface 2265 is configured to obtain and send signals for the communications device 2200 via communications link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210 and a computer-readable medium/memory 2230. In various aspects, one or more processors 2210 may be representative of the one or more processors 308, as described with respect to FIG. 3. The one or more processors 2210 are coupled to the computer-readable medium/memory 2230 via a bus 2250. In certain aspects, the computer-readable medium/memory 2230 is configured to store instructions (e.g., computer-executable code), including code 2235-2245, that when executed by the one or more processors 2210, cause the one or more processors 2210 to perform the method 1400 described with respect to FIG. 14, or any aspect related to it, including any operations described in relation to FIG. 14; the method 1700 described with respect to FIG. 17, or any aspect related to it, including any operations described in relation to FIG. 17; and the method 1900 described with respect to FIG. 19, or any aspect related to it, including any operations described in relation to FIG. 19. The computer-readable medium/memory 2230 is a non-transitory computer-readable medium/memory. Note that reference to a processor of communications device 2200 performing a function may include one or more processors of communications device 2200 performing that function, such as in a distributed fashion.

In the depicted example, the computer-readable medium/memory 2230 stores code (e.g., executable instructions), including code for receiving 2235, code for sending 2240, and code for performing 2245. Processing of the code 2235-2245 may enable and cause the communications device 2200 to perform the method 1400 described with respect to FIG. 14, or any aspect related to it; the method 1700 described with respect to FIG. 17, or any aspect related to it; and the method 1900 described with respect to FIG. 19, or any aspect related to it.

The one or more processors 2210 include circuitry configured to implement (e.g., execute) the code stored in the computer-readable medium/memory 2230, including circuitry for receiving 2215, circuitry for sending 2220, and circuitry for performing 2225. Processing with circuitry 2215-2225 may enable and cause the communications device 2200 to perform the method 1400 described with respect to FIG. 14, or any aspect related to it; the method 1700 described with respect to FIG. 17, or any aspect related to it; and the method 1900 described with respect to FIG. 19, or any aspect related to it.

Various components of the communications device 2200 may provide means for performing the method 1400 described with respect to FIG. 14, or any aspect related to it; the method 1700 described with respect to FIG. 17, or any aspect related to it; and the method 1900 described with respect to FIG. 19, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 2255, antenna 2260, and/or network interface 2265 of the communications device 2200 in FIG. 22, and/or one or more processors 2210 of the communications device 2200 in FIG. 22. Means for communicating, receiving or obtaining may include the one or more transceivers 312, one or more antennas 314, and/or processing system 306 of the first network entity 300 or the second network entity 302 illustrated in FIG. 3, transceiver 2255, antenna 2260, and/or network interface 2265 of the communications device 2200 in FIG. 22, and/or one or more processors 2210 of the communications device 2200 in FIG. 22.

### Example Clauses

Implementation examples are described in the following numbered clauses:

Clause 1: A method for wireless communications by a UE comprising: sending, for a core network entity, a data session modification request to move one or more QoS flows of a data session from a first RAN to a second RAN; receiving, from the second RAN, a data session modification response comprising an indication of at least one QoS flow, of the one or more QoS flows, to be moved to the second RAN; and receiving, from the second RAN, a RRC reconfiguration associated with the second RAN.

Clause 2: The method of Clause 1, further comprising: initiating the data session with the second RAN based on the RRC reconfiguration; and sending data associated with the at least one QoS flow to the second RAN.

Clause 3: The method of any one of Clauses 1-2, further comprising: maintaining a PDU session with the first RAN, wherein the PDU session is associated with the one or more QoS flows, wherein the first RAN comprises a 5G RAN.

Clause 4: The method of any one of Clauses 1-3, wherein the UE is configured for a dual-stack operation mode.

Clause 5: The method of any one of Clauses 1-4, further comprising sending the data session modification request based on a user plane measurement of a first RAN link for sending data between the UE and the first RAN, and a user plane measurement of a second RAN link for sending data between the UE and the second RAN.

Clause 6: The method of any one of Clauses 1-5, wherein sending the data session modification request comprises sending the data session modification request based on an access traffic steering, switching, and splitting rule for accessing the first RAN and the second RAN.

Clause 7: The method of any one of Clauses 1-6, further comprising sending the data session modification request to move the at least one QoS flow based on the UE communicating the one or more QoS flows via an application having a capability to access the first RAN and the second RAN.

Clause 8: The method of any one of Clauses 1-7, further comprising sending the data session modification request to move the one or more QoS flows based on a rule indicating a preconfigured distribution of traffic between the first RAN and the second RAN.

Clause 9: The method of any one of Clauses 1-8, wherein sending the data session modification request comprises sending the data session modification request based on one or more QoS parameters of the one or more QoS flows.

Clause 12: The method of Clause 9, further comprising sending the data session modification request to the second RAN.

Clause 10: The method of any one of Clauses 1-9, wherein the data session modification request comprises a PDU session identifier.

Clause 11: The method of any one of Clauses 1-10, wherein the data session modification request comprises a QoS parameter for satisfying a minimum QoS requirement corresponding to a respective QoS flow of the one or more QoS flows.

Clause 13: The method of any one of Clauses 1-12, further comprising: maintaining a DRB with the first RAN, the DRB associated with the one or more QoS flows, wherein the first RAN comprises a 5G RAN.

Clause 14: A method for wireless communications by a core network entity comprising: receiving, in association with a UE, a data session modification request to move one or more QoS flows of a data session from a first RAN to a second RAN; and sending, for the user equipment, a data session modification response comprising an indication of at least one QoS flow of the one or more QoS flows to be moved to the second RAN.

Clause 15: The method of Clause 14, further comprising determining the at least one of the QoS flows to be moved to the second RAN based on one or more policies of the core network entity.

Clause 16: The method of any one of Clauses 14-15, wherein the data session modification request comprises a PDU session identifier.

Clause 17: The method of any one of Clauses 14-16, wherein the data session modification request comprises a QoS parameter for satisfying a minimum QoS requirement corresponding to a respective QoS flow of the one or more QoS flows.

Clause 18: A method for wireless communications by a second RAN comprising: receiving, from a UE, a data session modification request to move one or more QoS flows of a data session from a first RAN to the second RAN; sending, to a core network entity, the received data session modification request; receiving, from the core network entity, an indication of at least one QoS flow of the one or more QoS flows to set up on the second RAN; sending, to the user equipment, a data session modification response comprising an indication of the at least one QoS flow of the one or more QoS flows to move to the second RAN; and sending, to the user equipment, a RRC reconfiguration associated with the second RAN.

Clause 19: The method of Clause 18, wherein the data session modification request comprises a PDU session identifier.

Clause 20: The method of any one of Clauses 18-19, wherein the data session modification request comprises a QoS parameter for satisfying a minimum QoS requirement corresponding to a respective QoS flow of the one or more QoS flows.

Clause 21: The method of any one of Clauses 18-20, further comprising performing an admission control to determine a list of accepted QoS flows.

Clause 22: A method for wireless communications by a UE comprising: sending, to a second RAN, during an establishment of a data session, a data session modification request to split one or more QoS flows of the data session between a first RAN and the second RAN; receiving, from the second RAN, a response to the data session modification request comprising a first set of accepted QoS flows to be set up on the first RAN, and a second set of accepted QoS flows to be set up on the second RAN; receiving, from the first RAN, a first RRC reconfiguration message; and receiving, from the second RAN, a second RRC reconfiguration message.

Clause 23: The method of Clause 22, further comprising determining a split of the one or more QoS flows between the first RAN and the second RAN based on a first user plane measurement of a first RAN link for sending data between the UE and the first RAN, and a second user plane measurement of a second RAN link for sending data between the UE and the second RAN.

Clause 24: The method of any one of Clauses 22-23, further comprising determining a split of the one or more QoS flows between the first RAN and the second RAN based on an access traffic steering, switching, and splitting rule for accessing the first RAN and the second RAN.

Clause 25: The method of any one of Clauses 22-24, wherein sending the data session modification request comprises sending the data session modification request based on one or more QoS parameters of the one or more QoS flows.

Clause 26: The method of any one of Clauses 22-25, further comprising sending the data session modification request to the second RAN.

Clause 27: The method of any one of Clauses 22-26, wherein the data session modification request comprises a list of one or more QoS flow identifiers for the first RAN.

Clause 28: The method of any one of Clauses 22-27, wherein the data session modification request comprises a list of one or more QoS flow identifiers for the second RAN.

Clause 29: The method of any one of Clauses 22-28, wherein the data session modification request comprises one or more data session identifiers for establishing the data session.

Clause 30: The method of any one of Clauses 22-29, further comprising sending, for a core network entity, a QoS parameter for satisfying a minimum QoS requirement corresponding to a respective QoS flow of the one or more QoS flows.

Clause 31: A method for wireless communications by a core network entity comprising: receiving, in association with a UE, a data session modification request to split, during an establishment of a data session, one or more QoS flows of the data session between a first RAN and a second RAN; sending, to the first RAN, based on policies of the core network entity, a first set of accepted QoS flows to set up on the first RAN; and sending, to the second RAN, based on the polices of the core network entity, a second set of accepted QoS flows to set up on the second RAN.

Clause 32: The method of Clause 31, further comprising receiving the data session modification request from the second RAN.

Clause 33: The method of any one of Clauses 31-32, wherein the received data session modification request comprises a first list of one or more QoS flow identifiers to be set up on the first RAN, and a second list of one or more QoS flow identifiers to be set up on the second RAN.

Clause 34: The method of any one of Clauses 31-33, wherein the data session modification request comprises one or more data session identifiers for establishing the data session.

Clause 35: The method of any one of Clauses 31-34, further comprising receiving, in association with the UE, a QoS parameter for satisfying a minimum QoS requirement corresponding to a respective QoS flow of the one or more QoS flows.

Clause 36: A method for wireless communications by a second RAN comprising: receiving, from a UE, during an establishment of a data session, a data session modification request to split one or more QoS flows of the data session between a first RAN and the second RAN; sending, to a core network entity, the data session modification request; receiving, from the core network entity, a list of accepted QoS flows to set up on the second RAN; sending, to the UE, a RRC reconfiguration message associated with the second RAN; and sending, to the UE, a data session modification response comprising an indication of at least one QoS flow of the one or more QoS flows to be set up on the second RAN.

Clause 37: The method of Clause 36, wherein the data session modification request comprises a list of one or more QoS flow identifiers to be set up on the first RAN.

Clause 38: The method of any one of Clauses 36-37, wherein the data session modification request comprises a list of one or more QoS flow identifiers to be set up on the second RAN.

Clause 39: The method of any one of Clauses 36-38, wherein the data session modification request comprises a QoS parameter for satisfying a minimum QoS requirement corresponding to a respective QoS flow of the one or more QoS flows.

Clause 40: The method of any one of Clauses 36-39, wherein sending the response to the data session modification request comprises performing an admission control to determine a list of accepted QoS flows to set up on the second RAN.

Clause 41: A method for wireless communications by a UE comprising: determining to split uplink data traffic between a first RAN and a second RAN based on a data split threshold; and sending, to the first RAN, a first buffer status report indicating a status of a first buffer storing data for a first split of the uplink data traffic for the first RAN.

Clause 42: The method of Clause 41, further comprising receiving, from the first RAN, an updated data split threshold.

Clause 43: The method of Clause 42, further comprising: determining an updated first split of the uplink data traffic for the first RAN based on the updated data split threshold; and sending, to the first RAN, the updated first split of the uplink data traffic.

Clause 44: The method of Clause 42, further comprising sending, to the first RAN, a second buffer status report indicating a status of a second buffer storing data for a second split of the uplink data traffic for the second RAN.

Clause 45: The method of Clause 42, further comprising sending, to the first RAN, a recommended updated data split threshold.

Clause 46: The method of Clause 45, wherein the updated data split threshold is associated with one of a QoS flow, a data radio bearer, a logical channel, or a logical channel group.

Clause 47: The method of Clause 41, further comprising: waiting for a defined interval and sending, to the first RAN, after the defined interval without receiving an updated data split threshold, the first split of the uplink data traffic based on the data split threshold.

Clause 48: A method of wireless communications by a UE, comprising: determining to split uplink data traffic between a first RAN and a second RAN based on a data split threshold; and sending, to the first RAN, a first buffer status report indicating a status of a first buffer storing data for a first split of the uplink data traffic for the first RAN.

Clause 49: The method of Clause 48, further comprising: receiving, from the first RAN, an updated data split threshold.

Clause 50: The method of Clause 49, further comprising: determining an updated first split of the uplink data traffic for the first RAN based on the updated data split threshold; and sending, to the first RAN, the updated first split of the uplink data traffic.

Clause 51: The method of Clause 49, further comprising: sending, to the first RAN, a second buffer status report indicating a status of a second buffer storing data for a second split of the uplink data traffic for the second RAN.

Clause 52: The method of Clause 49, further comprising: sending, to the first RAN, a recommended updated data split threshold.

Clause 53: The method of Clause 52, wherein the updated data split threshold is associated with one of a QoS flow, a data radio bearer, a logical channel, or a logical channel group.

Clause 54: The method of Clause 48, further comprising: waiting for a defined interval to receive, from the first RAN, an updated data split threshold; and sending, to the first RAN, after the defined interval, the first split of the uplink data traffic based on the data split threshold.

Clause 55: A method for wireless communications by a first RAN comprising: receiving, from a UE, a first buffer status report indicating a status of a first buffer storing data for a first split of uplink data traffic for the first RAN, wherein the uplink data traffic is split between the first RAN and a second RAN.

Clause 56: The method of Clause 55, further comprising sending, to the UE, an updated data split threshold.

Clause 57: The method of Clause 56, further comprising receiving, from the UE, an updated first split of the uplink data traffic.

Clause 58: The method of Clause 56, further comprising receiving, from the UE, a second buffer status report indicating a status of a second buffer storing data for a second split of the uplink data traffic for the second RAN.

Clause 59: The method of Clause 56, further comprising receiving, from the UE, a recommended updated data split threshold.

Clause 60: The method of Clause 59, wherein the updated data split threshold is associated with one of a QoS flow, a data radio bearer, a logical channel, or a logical channel group.

Clause 61: The method of any one of Clauses 55-60, further comprising: sending, to the UE, within a defined interval, an updated data split threshold; and receiving, from the UE, a second split of the uplink data traffic based on the updated data split threshold.

Clause 62: The method of any one of Clauses 55-61, further comprising receiving, from the UE, after a defined interval, the first split of the uplink data traffic based on a data split threshold.

Clause 63: One or more apparatuses, comprising: one or more memories comprising executable instructions; and one or more processors configured to execute the executable instructions and cause the one or more apparatuses to perform a method in accordance with any one of Clauses 1-62.

Clause 64: One or more apparatuses configured for wireless communications, comprising: one or more memories; and one or more processors, coupled to the one or more memories, configured to cause the one or more apparatuses to perform a method in accordance with any one of Clauses 1-62.

Clause 65: One or more apparatuses configured for wireless communications, comprising: one or more memories; and one or more processors, coupled to the one or more memories, configured to perform a method in accordance with any one of Clauses 1-62.

Clause 66: One or more apparatuses, comprising means for performing a method in accordance with any one of Clauses 1-62.

Clause 67: One or more non-transitory computer-readable media comprising executable instructions that, when executed by one or more processors of one or more apparatuses, cause the one or more apparatuses to perform a method in accordance with any one of Clauses 1-62.

Clause 68: One or more computer program products embodied on one or more computer-readable storage media comprising code for performing a method in accordance with any one of Clauses 1-62.

Clause 69: One or more apparatuses configured for wireless communications, comprising: a processing system that includes one or more processors and one or more memories coupled with the one or more processors, the processing system configured to cause the one or more apparatuses to perform a method in accordance with any one of Clauses 1-62.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
send, for a core network entity, a data session modification request to move one or more quality of service (QoS) flows of a data session from a first radio access network (RAN) to a second RAN;
receive, from the second RAN, a data session modification response comprising an indication of at least one QoS flow, of the one or more QoS flows, to be moved to the second RAN; and
receive, from the second RAN, a radio resource control (RRC) reconfiguration message associated with the second RAN.

2. The apparatus of claim 1, wherein the processing system is configured to cause the UE to:
initiate the data session with the second RAN based on the RRC reconfiguration message; and
send data associated with the at least one QoS flow to the second RAN.

3. The apparatus of claim 1, wherein the processing system is configured to cause the UE to:
maintain a packet data unit (PDU) session with the first RAN,
wherein the PDU session is associated with the one or more QoS flows, and
wherein the first RAN comprises a fifth generation (5G) RAN.

4. The apparatus of claim 1, wherein the UE is configured for a dual-stack operation mode.

5. The apparatus of claim 1, wherein the processing system is configured to cause the UE to send the data session modification request based on a user plane measurement of a first RAN link for sending data between the UE and the first RAN, and a user plane measurement of a second RAN link for sending data between the UE and the second RAN.

6. The apparatus of claim 1, wherein to cause the UE to send the data session modification request, the processing system is configured to cause the UE to send the data session modification request based on an access traffic steering, switching, and splitting rule for accessing the first RAN and the second RAN.

7. The apparatus of claim 1, wherein the processing system is configured to cause the UE to send the data session modification request to move the at least one QoS flow based on the UE communicating using the one or more QoS flows via an application having a capability to access the first RAN and the second RAN.

8. The apparatus of claim 1, wherein the processing system is configured to cause the UE to send the data session modification request to move the one or more QoS flows based on a rule indicating a preconfigured distribution of traffic between the first RAN and the second RAN.

9. The apparatus of claim 1, wherein to cause the UE to send the data session modification request, the processing system is configured to cause the UE to send the data session modification request based on one or more QoS parameters of the one or more QoS flows.

10. The apparatus of claim 1, wherein the data session modification request comprises a QoS parameter for satisfying a minimum QoS requirement corresponding to a respective QoS flow of the one or more QoS flows.

11. The apparatus of claim 9, wherein the processing system is configured to cause the UE to send the data session modification request to the second RAN.

12. The apparatus of claim 1, wherein the processing system is configured to cause the UE to:
maintain a data radio bearer (DRB) with the first RAN, the DRB associated with the one or more QoS flows, and
wherein the first RAN comprises a fifth generation (5G) RAN.

13. A method of wireless communication by a user equipment (UE), comprising:
sending, for a core network entity, a data session modification request to move one or more quality of service (QoS) flows of a data session from a first radio access network (RAN) to a second RAN;
receiving, from the second RAN, a data session modification response comprising an indication of at least one QoS flow, of the one or more QoS flows, to be moved to the second RAN; and
receiving, from the second RAN, a RRC reconfiguration associated with the second RAN.

14. An apparatus for wireless communications, comprising a processing system that includes one or more processors and one or more memories coupled with the one or more processors, the processing system configured to cause a user equipment (UE) to:
send, to a second radio access network (RAN), during an establishment of a data session, a data session modification request to split one or more quality of service (QoS) flows of the data session between a first RAN and the second RAN;
receive, from the second RAN, a response to the data session modification request comprising a first set of accepted QoS flows to be set up on the first RAN, and a second set of accepted QoS flows to be set up on the second RAN;
receive, from the first RAN, a first radio resource control (RRC) reconfiguration message; and
receive, from the second RAN, a second RRC reconfiguration message.

15. The apparatus of claim 14, wherein the processing system is configured to cause the UE to determine a split of the one or more QoS flows between the first RAN and the second RAN based on a first user plane measurement of a first RAN link for sending data between the UE and the first RAN, and a second user plane measurement of a second RAN link for sending data between the UE and the second RAN.

16. The apparatus of claim 14, wherein the processing system is configured to cause the UE to determine a split of the one or more QoS flows between the first RAN and the second RAN based on an access traffic steering, switching, and splitting rule for accessing the first RAN and the second RAN.

17. The apparatus of claim 14, wherein to cause the UE to send the data session modification request, the processing system is configured to cause the UE to send the data session modification request based on one or more QoS parameters of the one or more QoS flows.

18. The apparatus of claim 14, wherein the processing system is configured to cause the UE to send the data session modification request to the second RAN.

19. The apparatus of claim 14, wherein the data session modification request comprises a list of one or more QoS flow identifiers for the first RAN.

20. The apparatus of claim 14, wherein the data session modification request comprises a list of one or more QoS flow identifiers for the second RAN.

21. The apparatus of claim 14, wherein the data session modification request comprises one or more data session identifiers for establishing the data session.

22. The apparatus of claim 14, wherein the processing system is configured to cause the UE to send, for a core network entity, a QoS parameter for satisfying a minimum QoS requirement corresponding to a respective QoS flow of the one or more QoS flows.

23. A method of wireless communication by a user equipment (UE), comprising:
sending, to a second radio access network (RAN), during an establishment of a data session, a data session modification request to split one or more quality of service (QoS) flows of the data session between a first RAN and the second RAN;
receiving, from the second RAN, a response to the data session modification request comprising a first set of accepted QoS flows to be set up on the first RAN, and a second set of accepted QoS flows to be set up on the second RAN;
receiving, from the first RAN, a first radio resource control (RRC) reconfiguration message; and
receiving, from the second RAN, a second RRC reconfiguration message.
